(19) United States
(12) Patent Application Publication
(10) Pub. No.: US 2026/0247274 A1
(43) Pub. Date: Aug. 20, 2026

(54) WIRELESS MOBILE AD HOC VOICE AND DATA NETWORK

(71) Applicant: Lynq Technologies, Inc., Broomfield, CO (US)

(72) Inventors: Adam Gould, Poway, CA (US); Michael Wrape, Temescal Valley, CA (US); Jonathan Horne, Boulder, CO (US); Vikram Shah, Boulder, CO (US); Abhishek Vishwakarma, Iselin, NJ (US); Stan Okrasinski, Roanoke, VA (US); John Peter Norair, Jersey City, NJ (US)

(21) Appl. No.: 19/435,147

(22) Filed: Dec. 29, 2025

Related U.S. Application Data
(60) Provisional application No. 63/758,508, filed on Feb. 14, 2025.

(51) Int. Cl. H04W 48/20; H04W 40/24; H04W 84/18

(52) U.S. Cl. CPC H04W 48/20; H04W 40/24; H04W 84/18

(57) ABSTRACT

Methods, apparatus, and processor-readable storage media for implementing wireless ad hoc mesh networks are provided herein. An example computer-implemented method includes transmitting a connection graph to additional devices within an ad hoc mesh network; contributing to electing a repeater device, from the additional devices, to retransmit in a subsequent transmission frame information transmitted by the additional devices in a current transmission frame, including: using, upon a first condition that the first device transmitted during the current transmission frame, the connection graph to vote for one of the additional devices; and processing, upon a second condition that the first device did not transmit during the current transmission frame, votes from transmitting devices to determine an identity of the repeater device; and retransmitting, upon being elected as the repeater device, the information transmitted by the additional devices during the current transmission frame during the subsequent transmission frame.

### CROSS-REFERENCE TO RELATED APPLICATIONS

The present application claims priority to U.S. Provisional Application Ser. No. 63/758,508, filed Feb. 14, 2025, which is incorporated by reference herein.

### BACKGROUND

Various wireless communications standards exist for purposes of communicating voice, audio, video and/or other data. However, conventional wireless communications technologies typically include network architectures based on network topologies requiring fixed radio access infrastructure such as base stations, access points, and/or some other form of radio network controller. Accordingly, such conventional wireless communications technologies require users to be and/or remain within a limited range of one of these fixed equipment installations, and many such systems are cost-prohibitive and/or power consumption-prohibitive.

### SUMMARY

Illustrative embodiments of the disclosure provide wireless mobile ad hoc voice and data mesh networks and techniques related thereto.

An example computer-implemented method includes transmitting at least one connection graph to one or more additional devices within an ad hoc mesh network, wherein the connection graph represents connectivity status in connection with at least a portion of the ad hoc mesh network. Also, the computer-implementing method includes contributing to electing a repeater device, from among the one or more additional devices, to retransmit in a subsequent transmission frame information transmitted by at least a portion of the one or more additional devices in a current transmission frame, wherein contributing to electing the repeater device includes using, upon a first condition that the first device transmitted during the current transmission frame, the connection graph to vote for one of the one or more additional devices, and processing, upon a second condition that the first device did not transmit during the current transmission frame, one or more votes from one or more transmitting devices to determine an identity of the elected repeater device. Additionally, the computer-implemented method includes retransmitting, upon being elected as the repeater device, the information transmitted by the at least a portion of the one or more additional devices during the current transmission frame during the subsequent transmission frame.

Illustrative embodiments can provide significant advantages relative to conventional wireless communications technologies. For example, problems associated with range limitations and significant cost and/or power requirements arising from fixed infrastructure network architectures are overcome in one or more embodiments through configuring and implementing mesh network topologies utilizing connection graphs and elected repeater nodes.

These and other illustrative embodiments described herein include, without limitation, methods, apparatus, systems, and computer program products comprising processor-readable storage media.

### BRIEF DESCRIPTION OF THE DRAWINGS

FIG. 1 is a block diagram of a network configured for implementing a wireless mobile ad hoc voice and data network in an example embodiment.

FIG. 2 shows a wireless communication system in an example embodiment.

FIG. 3 shows an open systems interconnection (OSI) 7-layer model in an example embodiment.

FIG. 4 shows a comparison of an OSI 7-layer model to a mobile ad hoc voice (MAV) stack in an example embodiment.

FIG. 5 shows a subnet-node relationship in an example embodiment.

FIG. 6 shows MAV networking system frame and slot structure in an example embodiment.

FIG. 7 shows energy scan and sync transmit frames in an example embodiment.

FIG. 8 shows a data transmission frame preceded by an energy scan frame in an example embodiment.

FIG. 9 shows an overview of physical layer (PHY) and medium access control (MAC) time base error sources in an example embodiment.

FIG. 10 shows an illustration of a PHY get time callback delay in an example embodiment.

FIG. 11 shows a PHY-MAC time base resolution error in an example embodiment.

FIG. 12 shows a PHY-MAC time base offset error in an example embodiment.

FIG. 13 shows an initial PHY-MAC offset determination workflow in an example embodiment.

FIG. 14 shows a PHY-MAC time base resync workflow in an example embodiment.

FIG. 15 shows a MAC sync state finite state machine (FSM) in an example embodiment.

FIG. 16 shows a workflow related to implementing network synchronization in the RESET state in an example embodiment.

FIG. 17 shows example mesh topology in an example embodiment.

FIG. 18 shows source code in database (SCID) field encoding with respect to international telecommunication union (ITU) region-2 in an example embodiment.

FIG. 19 shows at least one physical channel descriptor (PCD) in an example embodiment.

FIG. 20 shows a workflow related to secure subnet admission phases in an example embodiment.

FIG. 21 is a flow diagram of a process for implementing a wireless mobile ad hoc voice and data network in an illustrative embodiment.

### DETAILED DESCRIPTION

As detailed herein, one or more embodiments include implementing wireless mobile ad hoc voice and data networks and techniques related thereto. As used herein an ad hoc network broadly refers to a decentralized network wherein devices connect and communicate directly with each other without a central access point, base station, fixed part and/or other infrastructure used to control, synchronize or otherwise orchestrate communications. There are many applications wherein it would be advantageous for users to leverage infrastructure-free forms of voice, audio, and/or data communications, particularly, for example, in locations wherein conventional fixed infrastructure based star-topology wireless networks do not exist and/or are impaired by unsatisfactory coverage and/or other environmental limitations. As further detailed herein, one advantage of infrastructure-free ad hoc networks is reliability of the network due to the lack of dependence on a single base station and/or access point control node. For example, if a base station and/or access point fails in conventional star topology networks, all users connected to that base station and/or access point will lose communications. In contrast, if a single node fails in a mobile ad hoc network, such as described herein in accordance with one or more embodiments, all other nodes in the network can still communicate with each other.

Similarly, in a conventional star topology network, each node is typically only in communications with the base station or access point control node. If a remote node goes out of range of the base station or access point, the remote node loses communications with every node on the network. In contrast, as detailed herein in connection with at least one embodiment, when a mesh topology is employed together with an ad hoc, distributed network, a node only needs to be in range of at least one neighbor node to continue communicating with other nodes on the network. Also, infrastructure-free wireless networks can benefit applications that are not operator controlled, wherein payment of subscription fees for network connectivity is often required.

By way merely of illustration, examples of user devices incorporating wireless technologies such as described herein can be found in U.S. patent application Ser. No. 18/238,188, entitled “Wireless Communication Systems with Long-Range, Infrastructure-Free Networking Capability” and filed on Aug. 25, 2023, which is hereby incorporated by reference herein in its entirety. Such example user devices can be used, for example, in military, police, and/or firefighter tactical headsets as well as in ruggedized headsets with hearing protection for high noise environments such as construction, oil, gas, mining, aviation ground crew applications, etc. Other applications can include, e.g., wireless belt-packs and/or all-in-one wireless headsets for the commercial intercom market.

Accordingly, in contrast to disadvantageous conventional approaches, one or more embodiments include generating and/or employing at least one mobile ad hoc voice network protocol to implement long range wireless infrastructure-free networks that can connect users over sizable distances for the purposes of voice, audio and/or data communications.

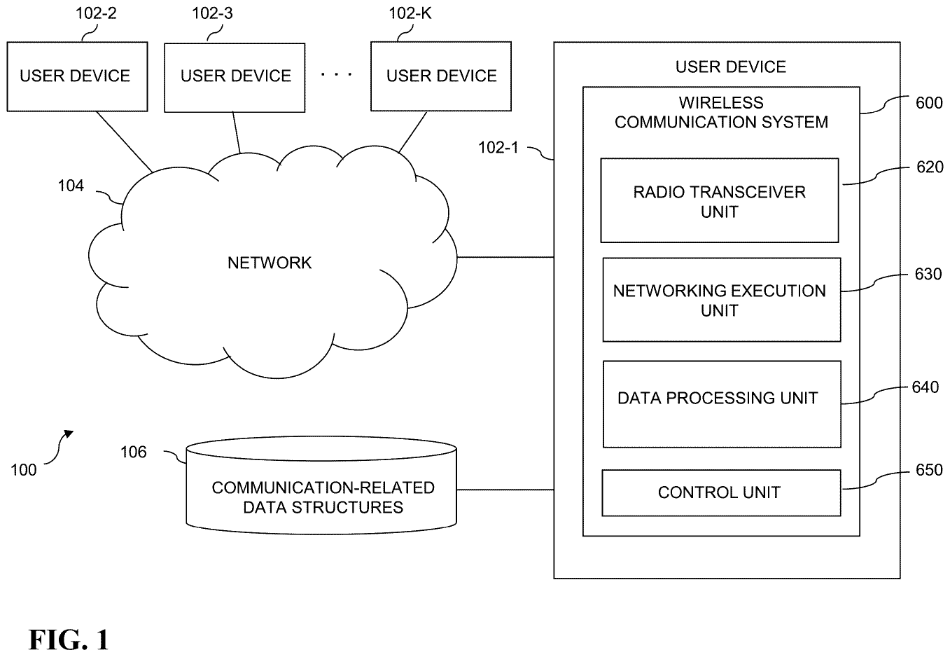

FIG. 1 shows a network 100 configured in accordance with an example embodiment. The network 100 includes a plurality of user devices 102-1, 102-2, 102-3, . . . 102-K, collectively referred to herein as user devices 102. The user devices 102 are coupled to a network 104, wherein the network 104 in such an embodiment is assumed to represent a sub-network or other related portion of the larger network 100. Accordingly, elements 100 and 104 are both referred to herein as examples of “networks,” but element 104 is assumed to be a component of element 100 in the context of the FIG. 1 embodiment.

The user devices 102 can include, for example, wireless headsets, remote speaker microphones (RSMs) (e.g., wireless RSMs), dongles (e.g., wireless dongles), relay nodes/devices, repeater nodes/devices, and/or one or more other communication-related devices. The user devices 102, as illustrated in FIG. 1, can connect, via wireless communication system 600, to one or more of the other user devices 102 (which also contain at least one instance of wireless communication system 600) via network 104.

By way merely of illustration, in the example embodiment depicted in FIG. 1, wireless communication system 600 is shown as resident on user device 102-1, but it is to be appreciated (and as further detailed herein) that other arrangements and/or configurations of the wireless communication system 600 and user devices 102 can be implemented.

Similarly, in at least one embodiment wherein wireless communication system 600 is part of and/or resident on user device 102 (such as shown in FIG. 1), the wireless communication system 600 in the FIG. 1 embodiment can be implemented using at least one processing device. Each such processing device can include at least one processor and at least one associated memory and can implement one or more functional software modules or components for controlling certain features of the wireless communication system 600. Also, in at least one embodiment, wireless communication system 600 can be coupled to a power source (e.g., at least one battery, etc.).

As noted, in one or more embodiments, the wireless communication system 600 and/or user devices 102 can include a processor coupled to a memory. The processor can include, for example, a microprocessor, a microcontroller, an application-specific integrated circuit, a field-programmable gate array or other types of processing circuitry, as well as portions or combinations of such circuitry elements. The memory can include, for example, random access memory (RAM), read-only memory (ROM), flash memory (e.g., wherein the executable code is stored, and the memory is non-volatile and can be written to), or other types of memory, in any combination. The memory and other memories disclosed herein can also be viewed as examples of processor-readable storage media, which can store executable computer program code and/or other types of software programs.

Examples of such processor-readable storage media can include, by way merely of example and not limitation, a storage device such as a storage disk, a storage array or an integrated circuit containing memory, as well as a wide variety of other types of computer program products. The term “processor-readable storage media” as used herein should be understood to exclude transitory, propagating signals.

As also detailed herein, wireless communication system 600 facilitates communication (e.g., communication by user devices 102) over the network 104 with other wireless communication systems and/or user devices, and can include, for example, one or more radio transceivers. In one or more embodiments, such a radio transceiver includes a radio providing the wireless connectivity to an infrastructure-free network such as further detailed herein.

Additionally, the wireless communication system 600 and/or user devices 102 can be coupled to one or more additional devices such as, for example, other user devices (including, e.g., mobile telephones, laptop computers, tablet computers, desktop computers or other types of computing devices).

The user devices 102, in one or more embodiments, can be coupled to respective computers and/or mobile devices associated with a particular group, organization or other enterprise. Numerous other operating scenarios involving a wide variety of different types and arrangements of processing devices and networks are possible, as will be appreciated by those skilled in the art.

Also, it is to be appreciated that the term “user” herein is intended to be broadly construed so as to encompass, for example, human, hardware, software or firmware entities, as well as various combinations of such entities.

The wireless communication system 600 and/or user devices 102 can also have one or more associated communication-related data structures 106 configured to store data related to one or more user devices 102, transmission information, communication mode information, temporal information, etc. In at least one embodiment, communication-related data structures 106 can be implemented using one or more storage systems associated with the wireless communication system 600 and/or user devices 102. Such storage systems can comprise any of a variety of types of storage including network-attached storage, storage area networks, direct-attached storage and distributed direct-attached storage, as well as combinations of these and other storage types, including software-defined storage.

Additionally, as used herein, the term data structure is intended to be broadly construed, so as to encompass, for example, a variety of different types of tables, graphs, arrays, trees, linked lists, and additional or alternative data relation mechanisms, as well as portions or combinations thereof. Accordingly, a given data structure can comprise a combination of two or more smaller data structures of one or more types, or a portion of a larger data structure.

Also optionally associated with the wireless communication system 600 and/or user devices 102 can be one or more input-output devices (not illustrated in FIG. 1), which can include, by way merely of example, keyboards, displays or other types of input-output devices in any combination. Such input-output devices can be used to support one or more user interfaces (UIs) to the wireless communication system 600 and/or user devices 102, as well as to support communication between the wireless communication system 600 and/or user devices 102 and other related systems and devices not explicitly illustrated in FIG. 1.

As additionally depicted in FIG. 1 and further detailed herein, wireless communication system 600 includes radio transceiver unit 620 (e.g., which facilitates wireless communications), networking execution unit 630, voice data processing unit 640 and control unit 650.

It is to be appreciated that the particular arrangement of elements 620, 630, 640 and 650 illustrated in the processor of the FIG. 1 embodiment is presented by way of example only, and alternative arrangements can be used in one or more other embodiments. For example, the functionality associated with elements 620, 630, 640 and 650 in other embodiments can be combined into a single module or separated across a number of modules. By way of further example, multiple distinct processors can be used to implement different ones of elements 620, 630, 640 and 650, or portions thereof.

Also, at least portions of elements 620, 630, 640 and 650 can be implemented at least in part in the form of software that is stored in memory and executed by a processor.

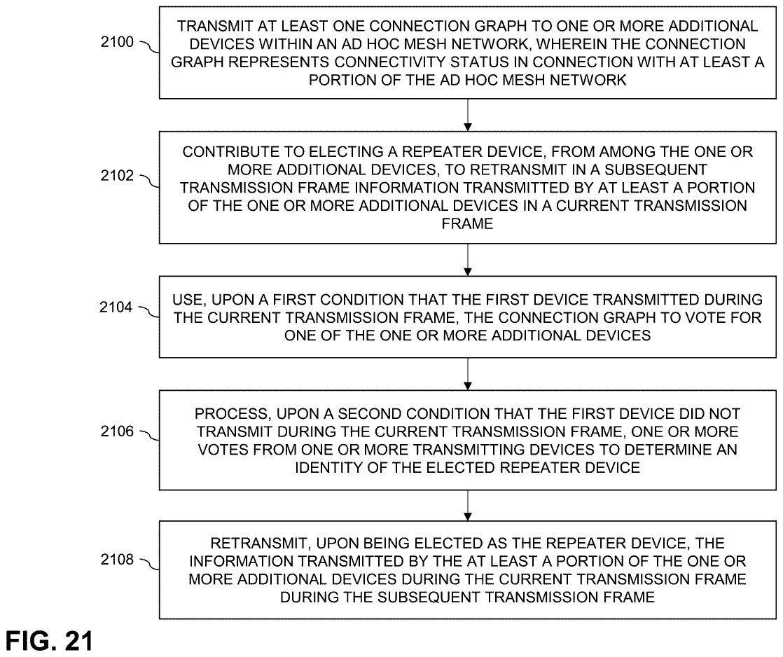

Further, an example process utilizing elements 620, 630, 640 and 650 of wireless communication system 600 in network 100 is described below, including in connection with the description of FIG. 21.

It is to be understood that the particular set of elements shown in FIG. 1 for implementation of wireless communication systems with low power, long-range, infrastructure-free networking capability is depicted by way of illustrative example only, and in one or more other embodiments, additional or alternative elements may be used. By way merely of example, in one or more other embodiments, the wireless communication system 600 can be eliminated and associated elements such as elements 620, 630, 640 and 650 can be implemented elsewhere in network 100.

As detailed herein, one or more embodiments include generating and/or implementing at least one long-range, wireless, infrastructure-free, self-forming mobile ad hoc networking system. A purpose of such a system is for the communication of real-time, low latency, full duplex (also referred to herein as “AllTalk”) or half duplex (also referred to herein as “Push-to-Talk”) voice and audio traffic amongst a number of wirelessly interconnected nodes over an infrastructure-free distributed network. Such a network can operate, for example, in a direct peer-to-peer fashion wherein each node is either a source or destination node (or both), and/or in a mesh topology wherein at least some nodes serve as intermediaries to receive and repeat voice and/or data traffic.

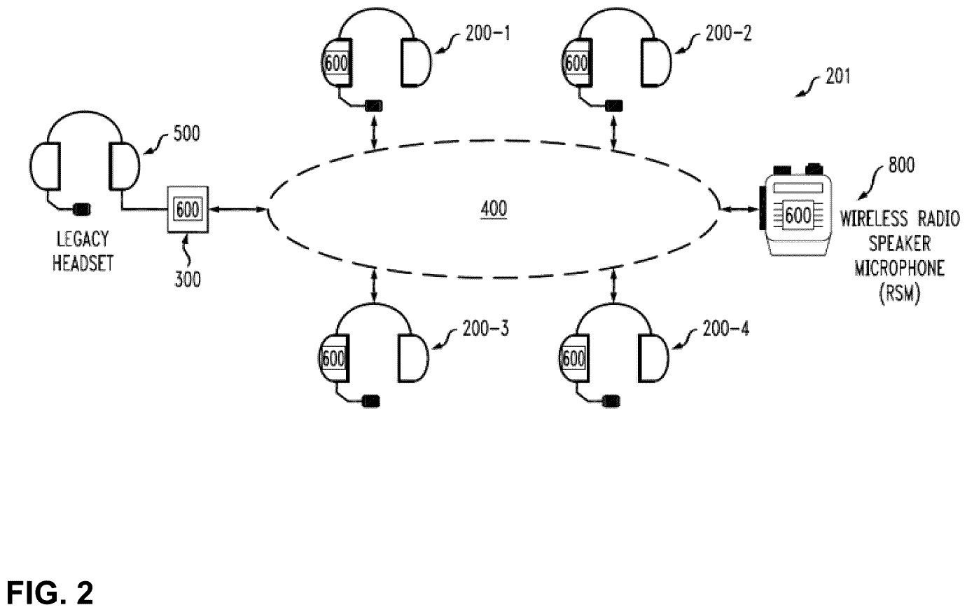

One example use case for such a network can include communication headsets equipped with integrated radios configured to form a long-range team communications wireless intercom system, such as detailed in FIG. 2. As noted above, examples of such communication headsets incorporating the wireless technologies described herein can also be found in U.S. patent application Ser. No. 18/238,188, entitled “Wireless Communication Systems with Long-Range, Infrastructure-Free Networking Capability” and filed on Aug. 25, 2023, which is hereby incorporated by reference herein in its entirety.

FIG. 2 shows a wireless communication system in an example embodiment. By way of illustration, FIG. 2 depicts a low power, long-range, infrastructure-free wireless headset network system 201 which includes wireless headsets 200-1, 200-2, 200-3 and 200-4 (collectively referred to herein as wireless headsets 200), a dongle 300 and an RSM 800 all equipped with a wireless communication system 600. The dongle 300, as detailed herein, enables legacy headset 500 (e.g., a cabled headset and/or a short-range wireless headset) to be connected to the infrastructure-free wireless headset network system 201.

In the example embodiment depicted in FIG. 2, wireless headsets 200 are each configured with wireless communication system 600, providing the wireless headsets 200 with low power, long-range, infrastructure-free wireless communications capability. Once configured, each wireless headset 200 is capable of becoming a communication network node. A wireless network 400, depicted in FIG. 2 and represented by the dashed-line oval, is dynamically created without any base stations, network controllers and/or other type(s) of infrastructure or communication arbiters whenever two or more network nodes (e.g., wireless headsets 200) are powered up and brought within range of each other to join the wireless network 400.

Once wireless network 400 is formed, any two or more network nodes that are successfully joined to the wireless network 400 are able to securely communicate with each other. One or more additional wireless headsets 200 that have also been previously configured for wireless network 400 can join the wireless network 400 (e.g., at any time). In a similar fashion, one or more of the wireless headsets 200 can also leave the wireless network 400 (e.g., at any time).

In at least one embodiment, dongle 300 (e.g., a wireless dongle) is also configured with wireless communication system 600 and can represent another network node type. Also, legacy headset 500 can then be attached (e.g., via a cable or wirelessly) to dongle 300, which then acts as a network adapter to enable legacy headset 500 to connect to wireless network 400 with the same wireless infrastructure free, low power, long-range communications capability as wireless headsets 200.

Additionally, as also depicted in FIG. 2, one or more embodiments can include wireless RSM 800 configured with wireless communication system 600, representing yet another network node type. Wireless RSM 800 can then be used for wireless infrastructure free, low power, long-range communications capability, similar to wireless headsets 200.

In one or more embodiments, the wireless communication system 600 associated with wireless headsets 200, wireless dongle 300 and wireless RSM 800 are set up and/or configured prior to the first usage. Configuring the wireless communication system 600 can include, for example, an initial setup of one or more network parameters and/or options, providing one or more cryptographic keys for secure communications and other parameters specific to the product application and/or use case. Once a node (e.g., a device) is configured, the node is able to form an instance of wireless network 400 during power-up together with other nodes that are within range of each other and configured in the same manner. Additionally, in such an embodiment, various devices and/or types of devices, provided that each has been configured with wireless communications system 600 and configured in a similar manner, are all able to communicate with each other while joined to wireless network 400.

As further detailed herein, one or more embodiments can include implementing support for one or more vocoders (for example, OPUS, G.722, LC3, LC3+, MELPe, etc.). Also, at least one embodiment can include functioning (e.g., transmitting data across multiple wireless headsets and/or other devices) over a long range which can be at least in part based upon the radio type implemented in the wireless communications system 600 (e.g., LoRa, DECT NR+, etc.) and/or the corresponding radio frequency (RF) spectrum (e.g., 915 MHz for LoRa, 1.9 GHz for DECT NR+, etc.), in a single hop (e.g., without mesh routing). In such an embodiment, range and data quality (e.g., voice quality) can be traded off depending, for example, upon a PHY option, RF spectrum band, selected vocoder option(s), etc.

One or more embodiments can also include implementing support for private communication (e.g., person-to-person), group communications (e.g., between multiple users on a network, but not all users), and/or broadcast communications (e.g., between all users on a network). In such an embodiment, support for multiple communication modes can include half-duplex push-to-talk (PTT) voice transmission and full-duplex “AllTalk” voice transmission, wherein all users on a given network can communicate in a fully conversational manner.

Additionally, at least one embodiment includes implementing support within the headset(s) for multi-channel communications on the same network. By way of example, such an embodiment can include configuring wireless communication system 600 with multiple (e.g., two) distinct and separate channels to route one group of talkers (e.g., an “A” squad) on wireless network 400 to the left earcup of a given headset and route other talkers (e.g., a “B” squad) on the wireless network 400 to the right earcup of the given headset. By way of further example, configuring wireless communication system 600 in the full-duplex “AllTalk” voice transmission mode can include prioritizing specific talkers (e.g., a group leader) to be heard at a higher volume and/or to cause lower priority talkers to be muted whenever a higher priority talker speaks.

Also, at least one embodiment includes implementing support for a secure voice network wherein wireless headset 200, dongle 300 and RSM 800 network node types are all admitted to the network via at least one cryptographic key exchange security mechanism, and wherein all communications control and traffic information is encrypted using at least one encryption technology (e.g., AES-256). In addition, users can be authenticated to use specific devices using, for example, personal identification number (PIN) code entry methods and/or voice fingerprinting methods wherein upon powering-up the device, the user speaks into the microphone of the device and the device compares the speaker's voice to a stored sample (i.e., a voice “fingerprint” of the user) of previously authorized user voice data to unlock the device for use.

Additionally or alternatively, one or more embodiments include implementing support for special purpose audio digital signal processing (DSP) within, e.g., wireless headsets 200, dongle 300 and wireless RSM 800 for voice activity detection (VAD), acoustic echo cancellation (AEC), and/or other DSP algorithms to improve audio quality, device usability and/or overall user experience, as well as to minimize unwanted sound and/or noise.

Further, at least one embodiment includes implementing support for simultaneous voice and data communications protocols, wherein a portion of each communication frame is dedicated to voice timeslots and at least a portion of the rest of the communication frame is available for non-voice data timeslots. By way of example, for voice timeslots, each talker on the network is assigned a specific logical communications channel with a unique set of channel parameters indicated by at least one or more (in the case, e.g., of frequency hopping) radio frequencies, a hopping sequence (in the case, e.g., of frequency hopping) and an assigned timeslot within each communication frame in a time division multiple access (TDMA) manner.

In one or more embodiments, and referring again to FIG. 2, wireless headsets 200, wireless dongle 300 and wireless RSM 800 can be further configured with additional non-voice capabilities to provide information (e.g., high value information) via the data communications portion of the wireless network 400 protocol to other users on/in the network and/or via at least one gateway to provide at least a portion of the information to one or more interested parties.

By way merely of example, such an embodiment can include equipping a wireless headset 200 with a global navigation satellite system (GNSS) receiver such that the wireless headset 200 can determine and track the user's position and report position location information (PLI) to one or more interested parties. Another example embodiment can include providing a backhaul communications link to connect a group member's body area network (e.g., including group member vitals, equipment sensors (such as, for example, a firefighter's oxygen tank level), live video streams, etc.) to one or more interested parties. By way of further example, such an embodiment can include obtaining safety critical information of the user's surrounding environment and sharing such information via wireless network 400 such that notice of unsafe situations can be output via the headsets in the form of an audio alarm and/or displayed on group members' heads-up display (HUD). Also, yet another example embodiment can include configuring wireless headsets 200, dongle 300 and RSM 800 with one or more accelerometer sensors and/or electronic compass sensors connected to wireless communication system 600 for the purposes of providing data (e.g., fall and/or shock data related to the accelerometer and the user's bearing information related to the compass as part of a PLI report) through the data communications portion of the wireless network 400 to one or more interested parties.

As also detailed herein, one or more embodiments includes enabling wireless network 400, via wireless communication system 600, to support voice and data traffic simultaneously. Such headset-to-headset voice and data networking capability can be beneficial for many use cases (e.g., for soldiers, added data capability can be used for sharing critical information required during a mission such as PLI, wireless headsets 200 being configured to act as a gateway to a soldier's body area network in order to backhaul soldier sensor data such biometric vitals, etc., for monitoring of health and/or safety parameters. By way of further example, workers in high-risk environments (e.g., oil refineries, underground and/or open pit mines, petrochemical plants, commercial aviation grounds, etc.) often require hearing protection and work with equipment that needs to be monitored for personnel safety and/or regulatory compliance. For example, consider a team of firefighters wearing oxygen tanks while fighting a fire. In such an example, it is imperative that the oxygen tanks be monitored to ensure oxygen levels are adequate while they are fighting the fire, and at the same time, the firefighters will need to communicate with each other and with a command center monitoring their progress in fighting the fire. For rural wildfire firefighting efforts, it may similarly be of vital importance to know each firefighter's physical location while being in direct communication with each firefighter over long ranges and wherein communications infrastructure may not exist and/or be readily accessible. In such a scenario, voice communications, GNSS and PLI can be shared between firefighters and with a command center via a gateway equipped with wireless communications system 600 for the purpose of connecting wireless network 400 to another network such as, for example, a private internet protocol (IP) network or the public internet.

Accordingly, the above are merely examples intended to illustrate the capability of one or more embodiments to combine voice and data communications over long ranges in infrastructure-challenged locations.

In addition to voice and audio network traffic, at least one MAV networking system such as detailed herein can include the capability to simultaneously communicate user data information over the network on an opportunistic basis. Such a MAV networking system can be implemented with multiple wireless network radio nodes executing exact replicas of the MAV networking stack (also referred to herein simply as the MAV stack) described herein, which are configured to adapt to at least one wireless standards-based PHY radio transceiver. Such radio transceivers can be implemented, for example, as systems-on-chip (SoC), systems-in-package (SiP), and/or hardware modules produced by semiconductor and/or module manufacturers. Such a MAV network hardware/software radio node can also be embedded within end-user voice, audio and/or data products (e.g., tactical and ruggedized communication headsets, wireless intercom belt-packs, wireless communication dongles, etc.) that each execute an exact replica of the long-range, wireless ad hoc networking stack (as further described herein) to implement the corresponding MAV networking system.

From the user's perspective, one or more embodiments improve upon and/or provide technical benefits over conventional networking solutions. By way merely of example, such an embodiment can include precluding a need for dependency on radio network infrastructure (such as, e.g., base stations, access points, fixed parts, dedicated controllers, arbiters, etc.). Additionally, such an embodiment can include providing that ability to operate the corresponding device from close distances (e.g., a few feet of separation between users) to long ranges (e.g., hundreds of meters or more between users), as well as providing high-quality natural sounding voice and/or audio data with low latency such that there is limited and/or no perceivable delay.

Also, at least one embodiment can include enabling an ability for a user to roam freely and stay in direct communications with a team or squad. For example, if a user roams out of range from the other users, the team of users can seamlessly regain communications when re-entering the network coverage area. Similarly, when a group of users roams beyond a coverage area of the rest of their group of users to form an island of communication, such users are able to communicate to one another within the island. When the group re-enters the coverage area of the other and/or larger group, the communications seamlessly reform the network such that all members from both groups can once again communicate to each other.

One or more embodiments can include performing secure network formation using cryptographic key exchange techniques to mutually authenticate at least a portion of the network devices (e.g., all network devices) when the network is initially formed and/or when a new and/or additional device enters the network. Further, at least one embodiment also includes encrypting voice, audio and/or other data traffic using one or more cryptographic technologies (e.g., AES-256) to ensure that no unauthorized device can eavesdrop on voice communications and/or make use of data that is exchanged over the network.

While at least one embodiment is described herein as at least one communication network at the system level, numerous innovations are additionally included within individual layers of the network architecture, as well as system level innovations that transcend multiple layers. As such, at least a portion of the innovations associated with such embodiments will be further detailed herein in accordance with various networking layers referenced within the context of an illustrative OSI 7-layer reference model, which depicts data flow in a communication system using seven specified abstraction layers. Additionally, as further detailed herein, differences between the OSI reference model and a model used for the communication system in one or more embodiments are highlighted and/or pointed out, when relevant, as well.

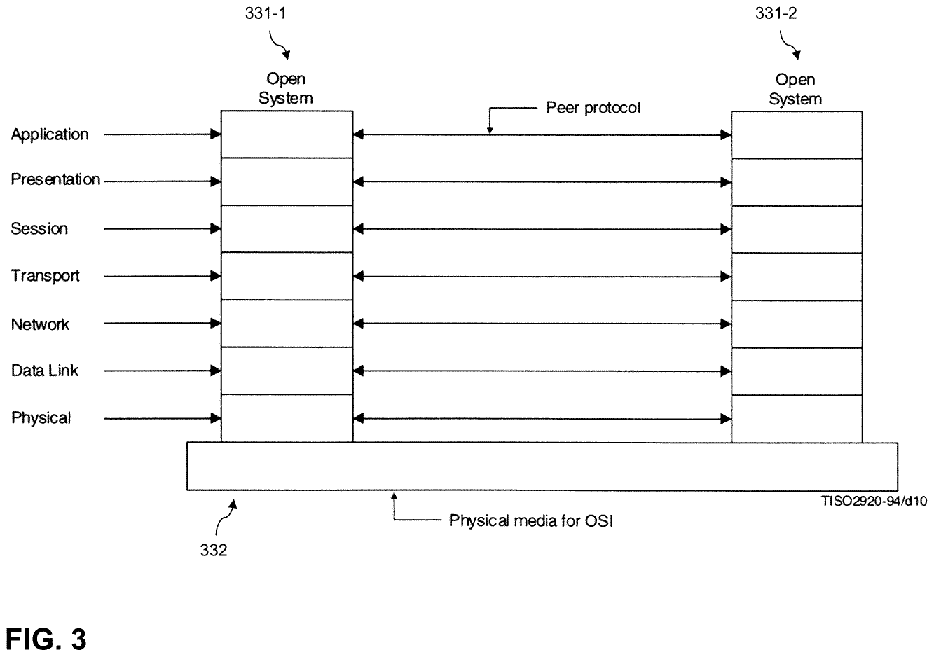

FIG. 3 shows an OSI 7-layer model in an example embodiment. By way of example, FIG. 3 depicts data, input from sources such as applications, presentations, sessions, transports, networks, data links, physical systems, etc., being processed by a first open system 331-1, which uses physical media for OSI 332 to implement at least one interactive peer protocol with a second open system 331-2.

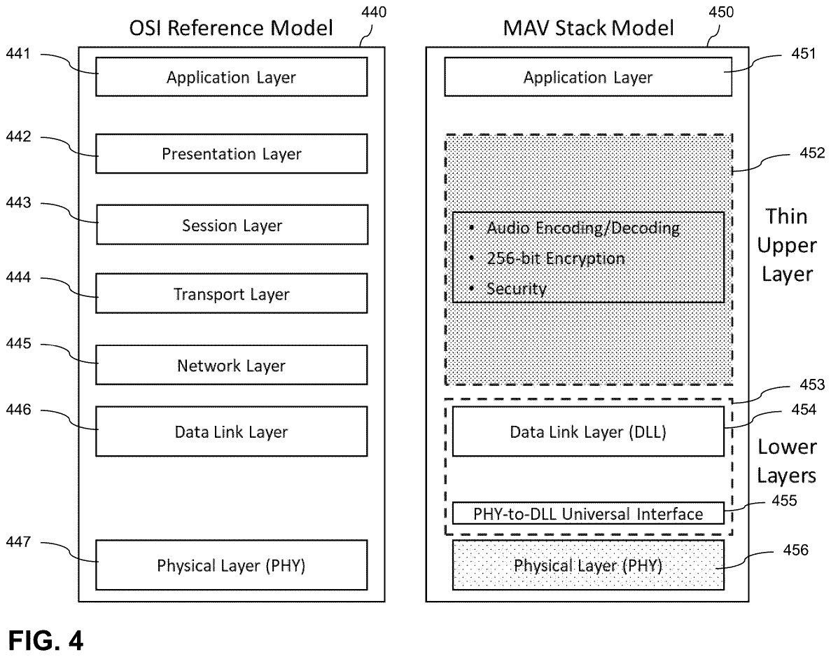

FIG. 4 shows a comparison of an OSI 7-layer model 440 to a MAV stack 450 in an example embodiment. By way of example, FIG. 4 depicts OSI 7-layer model 440, which includes application layer 441, presentation layer 442, session layer 443, transport layer 444, network layer 445, data link layer (DLL) 446, and PHY 447. Additionally, FIG. 4 also depicts MAV stack 450, which includes application layer 451, PHY 456, thin upper layer 452 (which includes capabilities for audio encoding and/or decoding, encryption, and security), and lower layers 453, which include DLL 454 and PHY-to-DLL universal interface 455.

As illustrated in FIG. 4, multiple elements of the MAV Stack with respect to the MAV network system (also referred to herein as the MAV networking system) itself is implemented in the lower layers 453, which can include an upper MAC function and a lower MAC (LOMAC) function as part of the DLL 454, and a PHY specific PHY-to-DLL universal interface 455 which serves as a thin adaptation layer. Also, at least a portion of the functionality above the DLL 454 in the thin upper layer 452 is described herein, such as aspects of encryption and secure authentication during network formation and node admission.

Additionally, as generally used herein, a device (e.g., a user device) can refer to any end-user product that is equipped with one or more instances of the MAV networking stack providing connectivity to an MAV networking system for the purposes of enabling the device to send and receive communication data. Examples of devices include, e.g., tactical communications headsets, wireless intercom belt-packs, all-in-one wireless headsets, etc. Also, as used herein, an island generally refers to a group of two or more nodes that are part of an operational subnet, but are separated and out-of-range with respect to at least one other group of two or more nodes in the same subnet. Further, as used herein, a node generally refers to a device with a single connection to at least one subnet, and a subnet, as used herein, generally refers to an instance of a MAV wireless network. Subnets can be differentiated from one another by the RF frequency on which they operate and/or their network identifier (ID), as further detailed herein. Also, in one or more embodiments, devices and/or nodes can communicate with each other over a subnet.

Additionally, as used herein, an enterprise network generally refers to an organizationally owned and/or operated network by which MAV network system nodes and/or devices may be associated with and/or authenticated against. For example, LoRaWAN networks can include, e.g., The Things Network (TTN) and Helium.

As detailed herein, one or more embodiments include generating and/or implementing a MAV networking system which is an ad hoc, decentralized wireless network with network control distributed amongst at least a portion of (e.g., all of) the active nodes, and wherein execution of the network protocol is facilitated by each node executing a replica of the MAV stack software on the node's wireless hardware. Such a system can enable the rapid formation device groups (e.g., subnets) for sending and receiving voice communications over long-range wireless intercom networks without the need for any radio access network infrastructure. Another system capability includes enabling transmission of user data (e.g., PLI from a GNSS receiver, body area network sensor information, etc.) simultaneously with voice traffic between network nodes using available system capacity on an opportunistic basis.

Devices, such as a tactical communications headset, that are equipped with the MAV stack can be provisioned (e.g., prior to operation) for use by configuring one or more operational parameters such as, e.g., RF channel, a network ID, device ID, etc. in order to prepare the devices to communicate with each other. After such provisioning, end users can simply power their devices on, and the MAV network forms around the devices and the end users can begin communicating with each other. Tactical communications headsets are noted above merely as one example, but it is to be appreciated that a MAV networking stack such as described herein in accordance with one or more embodiments can be embedded in a variety of devices and products (e.g., wireless intercom belt-packs, radio speaker microphones, motorcycle helmet intercom systems, smartphones, etc.). Additionally or alternatively, devices and/or products of different form factors can communicate with each other provided that the devices and/or products support the MAV networking stack.

While there is no limit to the number of devices that can be connected to a MAV networking system in one or more embodiments, an example embodiment described herein merely for purposes of illustration is configured to support up to 32 connected devices per subnet. In such an example embodiment, of those up to 32 connected devices per subnet, any three devices (or users thereof) can simultaneously talk at any given time to provide a conversational voice communication experience. From a network topology perspective, a MAV subnet can be configured to operate in a direct peer-to-peer topology, and/or can be configured in a mesh topology with the benefit of one or more repeater nodes to relay voice traffic between source and destination nodes to enhance communications (e.g., in difficult environments) and/or to increase operational range. Subnets are described further herein, and network topologies are also further discussed herein.

A challenge with ad hoc networks can include the initial synchronization of the individual network nodes and the ability to maintain that synchronization, especially when the nodes are mobile. Accordingly, one or more embodiments include implementing timing and subnet synchronization (sync) schemes that enable the MAV networking system to quickly sync and form at least one subnet, communicate low-latency high quality voice data, enable node mobility for teams that may be on-the-go, and leverage these schemes to maintain tight synchronization between all nodes. In one example embodiment, network timing synchronization of 100 microseconds or less is required for reliable communications and has been achieved with the schemes described herein.

In addition to the communications capability that the MAV networking system provides, the system implements security in a holistic manner, providing a highly secure network formation capability using cryptographic mutual authentication of connected nodes, and securing network voice data traffic using 256-bit encryption (e.g., such as that specified in the Advanced Encryption Standard or AES-256).

Architecture of the MAV stack software executing on each node in a designated group and/or subnet is such that it can be readily adapted to different wireless PHY radio transceivers, as further described herein. Flexibility at the PHY is also supported through operation in various RF unlicensed spectrum bands such as, for example, the US 915 MHz Industrial, Scientific and Medical (ISM) band, the 1,920 to 1,930 MHz US Unlicensed Personal Communications System (UPCS) band, and other similar unlicensed RF bands worldwide.

Because MAV networking system nodes can share the radio spectrum that they operate in with other non-MAV networking system radios, the nodes can be configured to cooperate in a friendly manner without perceptible interference. Hence, one or more embodiments include implementing a coexistence protocol to enable friendly operation in at least one unlicensed, shared spectrum without a central network controller (e.g., base station, fixed part, access point, etc.) and that is suitable to obtain regulatory approval of the protocol by various spectrum regulators (e.g., Federal Communications Commission, Industry Canada, the European Commission, etc.). A primary mechanism for friendly cooperation and/or coexistence with other devices in the same radio spectrum includes conducting an energy scan prior to the frame in which a node wishes to transmit as part of the MAV “Listen Before Talk” protocol. A discussion of such an energy scan sensing and collision avoidance protocol is described further herein.

With respect to MAV network subnets, when a group of properly configured nodes are powered-up and come together in an ad hoc manner to form a wireless network on the same RF channel, that network is referred to as a subnet. In an example embodiment, a single subnet can support up to 32 active nodes. However, as noted above, it should be appreciated by one skilled in the art that this number of nodes is merely used for illustrative purposes, and any number of nodes can be supported by the MAV network system disclosed herein.

Also, in one or more embodiments, MAV network nodes may form a new subnet and/or join at least one existing operational subnet over which the nodes can communicate. In such an embodiment, subnet principles can include the following. Any properly configured node can form a new operational subnet by being the first node to power-up in a given area of wireless coverage and by initiating the subnet formation protocol by periodically transmitting a sync packet which inherently communicates the subnet network ID and the node's network time and/or other parameters (such as further detailed below).

One or more additional nodes can JOIN a discovered active subnet that is in wireless range of the node(s), on the same RF frequency, and having the same network ID. In addition, the JOINING node(s) must also satisfy a designated level of admission security configured for the subnet. In at least one embodiment, different levels of network admission security can be implemented in the protocol, such as further described herein. Further, in one or more embodiments, a node can only JOIN a single subnet and all nodes admitted to the subnet can communicate with all other nodes that have been admitted to the subnet.

Also, in at least one embodiment, a router can be used to connect two subnets, for example, for the purpose of expanding the total number of users that can communicate with each other. In such an embodiment, the router can include a member device of the two subnets that has two instances of the MAV Stack executing, one for each subnet. For example, for a node on Subnet A to communicate with a node on Subnet B, the node must do so via a router.

Further, in one or more embodiments, the coverage area of one subnet on a particular RF frequency may overlap the coverage area of a second subnet that is configured with a different network ID but uses the same frequency. While the corresponding nodes share the same RF frequency, the nodes cannot communicate with each other across subnets because they do not share the same network ID. Additionally, a subnet can be contiguous or can include non-contiguous clusters and/or islands. In the non-contiguous case, the nodes are on the same RF frequency, share the same network ID, and have satisfied the security admission requirements for the subnet, but the islands are out-of-range of each other. If and when the islands come into range of each other, the islands can re-form into a single subnet.

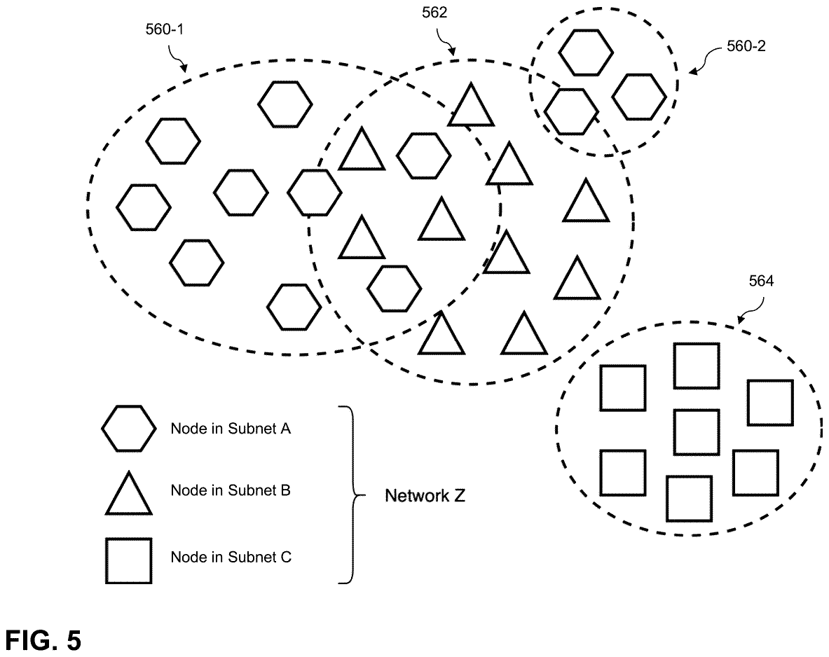

FIG. 5 shows a subnet-node relationship in an example embodiment. By way of example, FIG. 5 depicts the relationship between different subnets and their nodes, wherein the different subnets are part of a given enterprise network (Network Z). More particularly, FIG. 5 illustrates Subnet A, Subnet B and Subset C, all operating on the same RF frequency and with the scope of their wireless coverage illustrated by the dashed ovals around various nodes. Nodes that are members of a given subnet can communicate with all other member nodes of that subnet, provided that the member nodes are within range.

As depicted in FIG. 5, two islands, 560-1 and 560-2, are shown for Subnet A, and member nodes of Subnet A can only communicate within their island of coverage. Subnet B 562 overlaps both islands (560-1 and 560-2) of Subnet A, but the nodes of Subnet B 562 can only communicate with other nodes of Subnet B 562. In order for member nodes of Subnet A, across islands 560-1 and 560-2, to communicate with members of Subnet B 562, one node must be configured as a router running two instances of the MAV Stack which effectively couple the two subnets together. Further, as also depicted in FIG. 5, Subnet C 564 is isolated from the other subnets and its member nodes can only communicate with each other.

With respect to network and node configuration, the MAV network system, in one or more embodiments, is engineered to be simple to use from an end-user's perspective while also enabling significant levels of security. In order for individual nodes to simply power-up and begin communicating with other nodes, one or more parameters need to be configured for each node. As further detailed below, such parameters can include, for example, network ID, device ID, RF channel frequency, topology information, network talk mode, network security information, etc.

As described herein, a network ID can be used to identify an individual subnet. All nodes that intend to communicate over a given subnet must be configured with the same network ID. In one or more embodiments, a network ID is expressed as a binary value and can be of any length. For an example implementation of the MAV networking system adapted to the Digital Enhanced Cordless Telecommunications (DECT) 2020 PHY (also referred to as DECT NR+ and/or specified by the European Telecommunications Standards Institute in ETSI TS 103 636-3), a 32-bit network ID is specified in the DECT-2020 PHY standard. However, the DECT-2020 specification only supports transmissions of the 8 least significant bits (LSBs) of the network ID to the receiving nodes for comparison with their provisioned network ID to determine subnet membership of the transmitter and for use in filtering out packets that are intended for another subnet. The DECT-2020 PHY also uses the network ID as part of a scrambling algorithm for the PHY's physical data channel (PDC), and the manner in which the network ID is used for scrambling depends upon the header type selected for the PHY control field for the Physical Control Channel (PCC). In one or more embodiments, two different header types are possible: Type 1 and Type 2. In the case of a Type 1 header, only the 8-LSBs of the network ID are used as part of the scrambling algorithm for the PDC, and the other bits of the network ID are replaced with zeroes. Therefore, when a Type 1 header is specified, only the 8-LSBs of the DECT-2020 network ID are used. In the case of a Type 2 header, the upper 24 most significant bits (MSBs) of the network ID are used as part of the scrambling algorithm. Hence, for a Type 2 header, all 32-bits of the DECT-2020 Network ID are used to uniquely identify the network.

By way of illustration, in at least one example embodiment, the MAV network uses the Type 1 PHY control field header, and hence limits the useful portion of the 32-bit network ID to only the lower 8-LSBs. Note that a network ID of all zeroes is not permitted by the PHY specification. Therefore, in such an example embodiment, 255 unique subnets (1-255) can be provisioned for the MAV network system. Further, to configure a node to be part of a particular subnet, the node must be provisioned with the proper 8-bit network ID before attempting to JOIN the subnet. If a node is not expressly configured with a network ID before first use, the node can use the default network ID that is programmed into the node firmware at the time of manufacture. A node can be re-configured for use on a different subnet by modifying its network ID.

On a given subnet, the device ID (also referred to herein as the radio ID) is used to distinguish one node from another. As with the network ID, the device ID can be of any length. By way merely of illustration, in at least one example embodiment, the MAV network system protocol can support assignment of a 5-bit device ID that uniquely identifies up to 32 nodes for a given subnet. As also with the network ID, the node must be provisioned with a device ID before attempting to JOIN a subnet, and the device ID must be unique with respect to all other nodes provisioned for the same subnet. In the case of a device ID, there is no default ID because all nodes must have a unique device ID to differentiate them from one another.

Additionally or alternatively, the MAV networking system can also take advantage of a much larger device ID that enables many more nodes on a subnet. For example, the DECT-2020 PHY supports a 16-bit short radio device ID and a 32-bit long radio device ID for substantial flexibility for MAV network systems when used in conjunction with a DECT-202 PHY.

In addition to requiring configuration of the same network ID to communicate over a given subnet, in one or more embodiments, all nodes must be configured to use the same RF channel frequency. The set of permissible frequencies to select from can be determined by the radio standard which the chosen PHY transceiver is implementing. For example, for the DECT-2020 PHY, the specification supports a number of different frequency bands including those specified across the globe for the classic DECT standard in the 1.8 and 1.9 GHz spectrum. In this case, the supported frequency channels for both North America (DECT-2020 band 9) and the European Union (DECT-2020 band 1) countries, as well as other countries following the EU frequency assignments, are shown in Table 1 below. In addition, other bands such as the US 915 MHz ISM band (DECT-2020 band 4) can be supported as well.

TABLE 1

| Logical RF | | Channel Center |
|---|---|---|
| Channel No. | Region | Frequency |
| 15 | US/CAN | 1928.448 MHz |
| 14 | US/CAN | 1926.720 MHz |
| 13 | US/CAN | 1924.992 MHZ |
| 12 | US/CAN | 1923.264 MHz |
| 11 | US/CAN | 1921.536 MHz |
| 10 | EU (and other regions) | 1899.072 MHz |
| 9 | EU (and other regions) | 1897.344 MHz |
| 8 | EU (and other regions) | 1895.616 MHz |
| 7 | EU (and other regions) | 1893.888 MHz |
| 6 | EU (and other regions) | 1892.160 MHz |
| 5 | EU (and other regions) | 1890.432 MHz |
| 4 | EU (and other regions) | 1888.704 MHz |
| 3 | EU (and other regions) | 1886.976 MHz |
| 2 | EU (and other regions) | 1885.248 MHz |
| 1 | EU (and other regions) | 1883.520 MHz |
| 0 | EU (and other regions) | 1881.792 MHz |

As with the network ID, to configure a node to operate on the proper RF channel frequency, the node must be provisioned with the correct logical RF channel number corresponding to the subnet's intended RF channel center frequency of operation before attempting to JOIN the subnet. For example, the MAV logical channel number maps to the DECT-2020 RF channel center frequencies for the European Union and North American 1.8 and 1.9 GHz bands, respectively.

As also detailed herein, in at least one embodiment, the MAV networking system supports peer-to-peer direct communication topology as well as mesh topology. For the network to function, all nodes on the given subnet must be configured with the same topology mode prior to attempting to JOIN the subnet. In one or more example embodiments, the MAV stack contains a mesh configuration parameter that when set to “1” enables the mesh topology network mode as the default. When set to “0,” the direct non-mesh network topology is selected.

As also detailed herein, the MAV networking system can support multiple talk modes including, for example, a multi-user push-to-talk (PTT) mode and a full-duplex AllTalk mode. The AllTalk mode can encompass a conversational hands-free mode wherein users talk in a natural way with multiple talkers speaking, at least occasionally, at the same time. In one or more embodiments, AllTalk mode is complemented by at least one voice activity detection (VAD) algorithm to limit the transmission of background noise over the MAV network and to save battery power by limiting the amount of time that the transmitter is active. PTT mode can differ from AllTalk mode, for example, by requiring the user to depress a PTT-related button on the device in order to activate the transmitter and talk. Additionally, in at least one embodiment, the MAV networking system's PTT talk mode can differ from conventional PTT systems as multiple talkers can talk simultaneously whereas in conventional systems, typically only one talker can speak at a time. Unlike the selection of network topologies that require all nodes on a subnet to be configured with the same topology, individual nodes on the same subnet can operate with different talk modes.

Also, as detailed above and herein, one or more embodiments include configuring one or more network security parameters. In such an embodiment, aspects related to network security that must be properly configured before network communications on a subnet can take place can include node authentication for admission to the subnet and encryption of the actual voice/data traffic prior to transmission over the network.

At least one embodiment includes performing techniques related to subnet formation and node entry and/or exit. More particularly, such an embodiment includes forming a MAV network, and enabling nodes to enter and exit an operational network. With respect to initial subnet formation, unlike conventional wireless radio systems that use some form of star topology with one or more base stations, access points, and/or fixed part network controllers, the MAV network system can be ad hoc and distributed with respect to network control. In one or more embodiments, all nodes are configured with the same networking software without any configuration of a particular node to be a controller, and in such an embodiment, MAV network subnets can be formed and terminated on the fly (for example, by turning two or more nodes ON and then turning the two or more nodes OFF).

As a prerequisite to the formation of a subnet for a group of devices to communicate over, all such devices must have been configured properly as described herein. It is also important to note that the subnet formation process is not necessarily a one-time event. Each and every time a group of devices power up for the purposes of communicating together, an operational subnet can and/or must be formed. Subnet formation can begin with the power-up of at least one of the devices/nodes that wish to communicate over the subnet. After node boot-up and initialization, the node's PHY is placed into a continuous receive mode to begin searching for other properly configured nodes with which to communicate. Because there is no actual network protocol or synchronization established at this point, the node is listening for a recognizable transmission from another node. Periodically, the subject node can transmit a synchronization packet (sync packet) on the unformed subnet's assigned RF channel frequency for one or more other nodes to discover that are also listening on the same channel prior to formation of the subnet.

Once two or more nodes have powered up and received each other's sync packets as an indication that a subnet can be formed, the nodes use the timing information contained in each other's sync packets to align their internal timing references as part of an initial synchronization process. After timing alignment, subnet formation continues with subnet admission (i.e., JOIN) based at least in part on the pre-configured network security admission level.

Also, one or more embodiments include enabling nodes to join operational subnets. By way of example, consider a scenario wherein a node is powered up, has gone through its boot-up and initialization process, and has been pre-configured to JOIN a subnet (e.g., a given RF channel, a given Network ID, a compatible subnet topology mode, proper AES-256 encryption key, proper admission credentials for level 3 admission, etc.) that is already operational with two or more active nodes communicating with each other. As with the initial subnet formation, the entering node may have no knowledge of whether an operational subnet exists that it can JOIN. Hence the node starts in a continuous receive mode, searching for a recognizable transmission from at least one other node. In this case, the node finds other nodes that are already communicating with each other, either in exchanging their sync packets during network idle times (i.e., when no voice transmissions are taking place) or during reception of voice traffic from one or more nodes. In either case, timing and synchronization information from other transmitting nodes is available in packets received by the JOINING node that enable the node to align its own internal time base to JOIN the subnet. Once this alignment has completed, the node enters the subnet admission process based at least in part on its pre-configured network admission security level, similar to the techniques described above for initial subnet formation.

There are multiple ways that a connected node can exit an operational subnet. For example, a node can exit a subnet via a disconnect command (e.g., from the product application), by turning the power off on the node (which will disconnect the node from the subnet), etc. Additionally or alternatively, if the node moves out-of-range with respect to the other nodes in the subnet, the node may eventually be recognized by the connected nodes as being disconnected. If the out-of-range condition is temporary and the node comes back into range within a given amount of time, the node can reestablish communications without going through the network admission process.

MAV network subnet islands can form, for example, when two or more operational subnets exist with the same configuration (e.g., the same RF channel frequency, the same network ID, the same security credentials, etc.), but are out-of-range with respect to each other. One factor that can result in the creation of islands is mobility of the nodes within a subnet. Such as detailed below in the noted examples, there can be a number of different scenarios wherein subnets split and form islands, as well as a number of scenarios wherein existing islands come into range of each other and merge to reform as one subnet.

For example, island formation can occur due to group separation. In this scenario, a single operational subnet can be initially formed, e.g., by four or more nodes. The nodes begin moving and, at some point, separate into two groups or islands of two or more nodes by moving out-of-range with respect to each other. The nodes within the two islands that are within range of each other continue to communicate with each other in a seamless fashion. However, the nodes in different islands lose the ability to communicate with each other because they are out-of-range. Note that in the case of fully secure subnet admission (e.g., Level 3, as described herein), when an island forms that does not include the original JOIN arbitrator node, one of the nodes within the island takes on the role of the arbitrator to facilitate the secure online JOIN process for any incoming unauthenticated nodes to the island subnet.

In the type of scenario, wherein two island subnets are formed by two groups of nodes going out-of-range with respect to each other, once the nodes come back into range of each other, the original single subnet re-forms seamlessly such that all of the nodes are able to communicate with each other and no re-authentication for nodes within the subnet configured with the fully secure Level 3 admission policy is required.

Another example scenario can include merging two independent islands into one subnet. By way of illustration, consider a case wherein a fire department has 15 tactical headsets, each equipped with a MAV network node for the purposes of local squad communications between the firefighters, and the headsets are all pre-configured to operate on the same subnet. A fire alarm rings in the firehouse and 10 firefighters head to the scene and power their headsets up to communicate with each other. Accordingly, a first operational subnet is formed with these initial 10 headsets worn by corresponding firefighters. Later, another alarm is received by the firehouse for the same fire. The remaining five firefighters grab their headsets as they leave the firehouse, power up the headsets, and begin speaking with each other on the way to the fire, thus forming a second island subnet with the same subnet configuration as the first island. Consequently, there are two islands of headsets belonging to the same subnet that are actively being used to communicate with two isolated groups of firefighters. These islands were formed at different times, and the second island was not in range of the first island when the second island became operational. Additionally, when the second squad arrives on-scene, the two island subnets seamlessly merge into a single subnet such that all 15 firefighters have uninterrupted communications with each other.

Another example scenario can include incoming authenticated node admission to separate islands. More particularly, in the case of two or more active islands that are configured in the same manner, any incoming authenticated (e.g., authentication as applicable only to an admission Level 3 fully secure subnet, as described herein) node that is also configured with the same subnet credentials can JOIN either of the two active islands when the node comes into range with one of the islands, provided that there are less than the maximum number of active nodes allowed by the protocol within the island.

Alternatively, another example scenario can include incoming non-authenticated node admission to separate islands. This can encompass the same general circumstances as described in the above scenario with the exception that for an island that is part of a Level 3 admission security subnet, the incoming node has not yet been authenticated for the subnet. In this case, the island's selected JOIN arbitrator will facilitate the secure JOIN process to authenticate the incoming node as described herein. Note that with subnet islands, it is possible to have multiple JOIN arbitrators operating simultaneously as non-authenticated nodes request to join the Islands.

Once a subnet is formed among two or more nodes, normal operation of the networking protocol can commence to enable ongoing synchronization across the subnet and successful communication of voice transmissions. In at least one embodiment, the MAV networking system employs a Time Division Multiple Access (TDMA) MAC layer. As such, transmitting nodes are separated in time by only being allowed to transmit within an assigned “talk slot” within each communication frame. Accordingly, within a frame, multiple nodes can transmit simultaneously, with each node transmitting only during their designated time slot in a TDMA fashion. Aspects of such a protocol can include, for example, a PHY slot which is defined by the PHY specification (e.g., ETSI DECT-2020 PHY specification), a PHY sub-slot which is half the duration of a corresponding PHY slot, a MAC layer slot that includes a certain number of PHY slots (also referred to herein as a talk slot), a communication frame that includes a certain number of MAC slots and PHY slots, and a superframe which includes an even number of communication frames.

By way merely of illustration, for the example implementation of the MAV networking stack on the DECT-2020 PHY, such noted aspects of the protocol can have the following specific values: PHY slot duration of 416.667 microseconds; Number of PHY slots per frame=24; Number of PHY slots per MAC slot=6 (including 4 MAC slots or talk slots per frame); Transmitter active duration=2 PHY slots within a talk slot; Frame duration=10 milliseconds (ms); Number of frames in a superframe or sync interval=64.

It is to be appreciated by one skilled in the art that these parameters are merely examples and that the implementation of the MAV networking system in one or more embodiments is not limited to these specific values. Rather, given the adaptability of the MAV network stack to different PHYs, such values can be parameterized and part of a flexible adaptation of the stack to different PHYs.

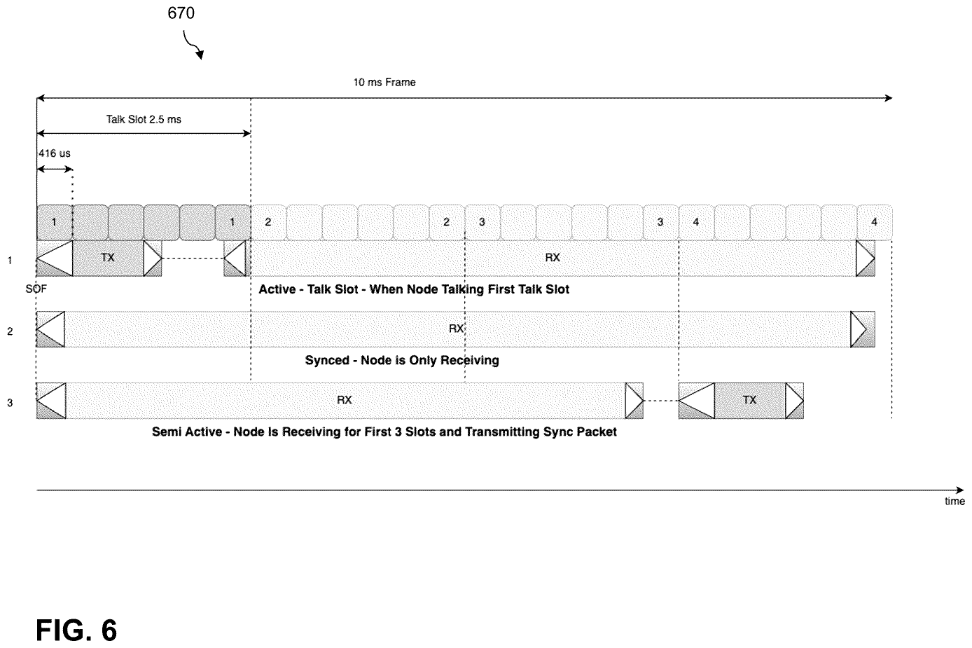

FIG. 6 shows MAV networking system frame and slot structure 670 in an example embodiment. By way of example, and as detailed above, FIG. 6 illustrates example networking system frame and slot structure 670, which depicts a PHY slot, a MAC slot and communication frame relationships for an example embodiment implementing the MAV networking system using the DECT-2020 PHY.

Additionally, one or more embodiments can include implementing one or more MAV networking system communication frame types. For example, in such an embodiment, a MAC function contains a state machine that controls the primary MAC operations to maintain subnet synchronization and support implementation of the networking protocol. Different frame types can be used within the different MAC states in order to execute various MAC operations as specified in the frame descriptions. For instance, such MAC states can include, e.g., a RESET state, a SYNC state, a SEMI_ACTIVE state, a FULLY_ACTIVE state, and a SENSE state.

An energy scan frame can be used by nodes on a subnet to measure the energy level across the duration of the frame prior to the frame in which a node is to begin a transmission as part of a “Listen Before Talk” assessment. During an energy scan which is performed in the MAC SENSE state, the MAC schedules a PHY received signal strength indication (RSSI) operation, wherein the PHY measures and returns detected electromagnetic energy levels across the frame as an indication of the presence of at least one other interfering radio system operating in the same RF spectrum. If no energy is discovered within the frame, then the node can commence its transmission in its assigned talk slot during the next frame. This energy scanning operation supports an interference-free operation in a manner to enable coexistence of different types of radios using the same unlicensed shared spectrum (e.g., different systems can include another MAV network system operating on the same RF channel frequency with different Network ID and/or another radio system (such as a classic DECT system) operating on the same RF channel). In at least one embodiment, implementation of such a feature can be a requirement to obtain regulatory certification by spectrum regulators (e.g., such as the Federal Communications Commission (FCC) in the United States).

In one or more embodiments, nodes that are part of a MAV networking system can support different types of transmissions, such as, for example, a periodic sync packet transmission by each connected node on a subnet during its assigned sync transmit frame within a sync interval, and the transmission of user voice packets during a node's assigned talk slot using a data transmit frame. The energy scan protocol behaves differently for these two transmission types. For example, when there is no voice communication activity occurring on the network (e.g., the network from the end user's perspective is IDLE), the connected nodes maintain network synchronization by periodically sharing their sense of network system time with each other through transmission of sync packets. For example, in an example embodiment, each node transmits their sync packet during 1 of 32 assigned sync transmit frames, wherein frame assignments are determined through a relationship between each node's unique device ID and the assigned frame number for transmitting its sync packet. In order to avoid over-the-air contention with another radio system, an energy scan frame can precede every sync transmit frame to allow each transmitting node to check for interference. Accordingly, in the above-noted example embodiment, in a sync interval, there are 32 10 ms sync transmit frames, each preceded by 32 10 ms energy scan frames providing a sync interval duration of 640 ms.

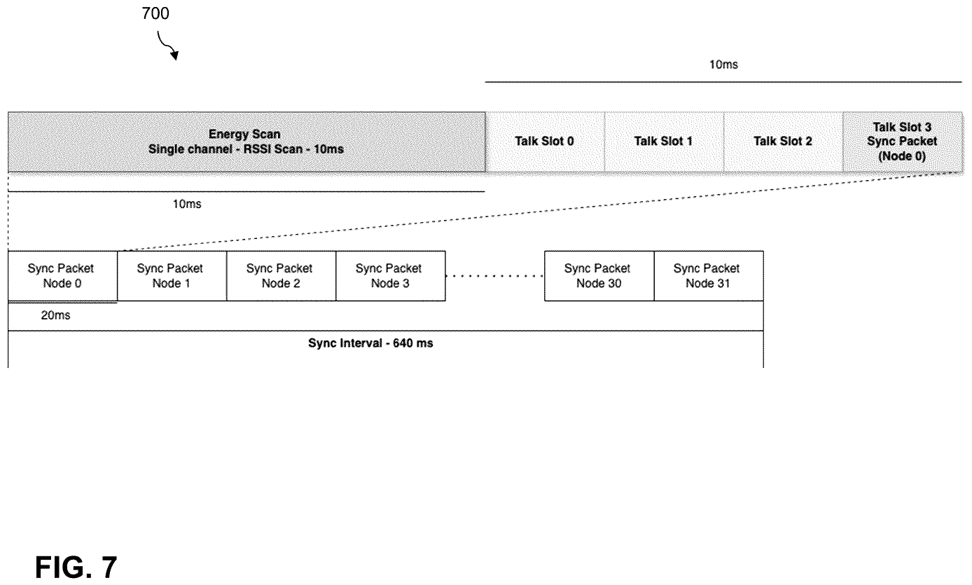

FIG. 7 shows energy scan and sync transmit frames in an example embodiment. By way of example, and as detailed above, FIG. 7 depicts a structure view 700 of an energy scan frame and subsequent sync packet transmission frame for a node with device ID 0.

Additionally or alternatively, for node transmissions in the case of user voice packets, the transmitting node performs an energy scan prior to the frame that it intends to begin transmission of the first packet in a multi-packet voice message, similar to transmission of an individual sync packet. However, once the node determines that there is a free talk slot available during the energy scan, the node commences transmission of the multi-packet voice message in the same talk slot of the next frame, and continues transmitting in the same talk slot of subsequent frames until the voice transmission is completed without performing another energy scan.

As described herein in connection with energy scan frames, when there is no user voice communication on a subnet, the network is in a continuous synchronization mode wherein all active nodes participate in a repetitive sync interval (e.g., a repetitive 640 ms sync interval). During this sync interval, for example, one 10 ms energy scan frame to ensure that the RF channel is clear, followed by one 10 ms sync transmit frame can be allocated for each of 32 potentially connected nodes on the subnet. In such an example embodiment, the node with device ID 0 is assigned to the first sync transmit frame, the node with device ID 1 is assigned the second sync transit frame, and so on, with device ID 31 assigned to the 32^{nd} sync transmit frame. When a particular node's turn at transmitting their sync packet comes up, the node transitions from its SYNCED state to the SEMI_ACTIVE state which is reserved for the assigned node to transmit its sync packet. Once the sync interval has elapsed, the sync interval can repeat. When an active transmission of audio data commences, this continuous sync process is interrupted with transmissions of voice data.

A purpose of the sync transmit frame can include, for example, for each node to send their timing information to all of the other connected nodes within a single sync packet transmitted within the frame. These sync packets can be transmitted, for example, in the fourth talk slot of each node's assigned sync transmit frame, and the timing information that each node conveys within its sync packet can include its internally maintained 64-bit MAC time. The node timing information can be used to initially synchronize and maintain accurate timing across the subnet. Further, the format and contents of a sync packet are further described herein in connection with one or more embodiments.

As also detailed herein, during the sync interval, one node at a time transmits their sync packet using their assigned sync transmit frame period. During this time, all other connected nodes on the subnet are in the SYNCED state and schedule their PHYs to conduct a receive operation for the duration of the frame in order to capture the sync provider's sync transmit frame containing the provider's sync packet. From the listening nodes' perspective, these durations are considered sync receive frames. In other words, the sync provider's sync transmit frame is the sync receive frame for all of the other active nodes on the subnet.

Additionally, when an end-user begins speaking into the microphone (MIC) of their MAV network stack-equipped device, digital voice packets are created within the stack and cause the node's MAC to begin initiation of a voice transmission process over a subnet. This voice packet data is communicated within a data transmission frame by a talker that has audio data to send, and once the talker has determined that it has a free slot to transmit in during the next frame, the talker node transitions into the FULLY_ACTIVE state to perform the transmission.

In an example embodiment, the frame can be equally divided into four 2.5 ms talk slots at the MAC layer, each of which includes 6 PHY slots, thus occupying an entire 24 PHY slot frame.

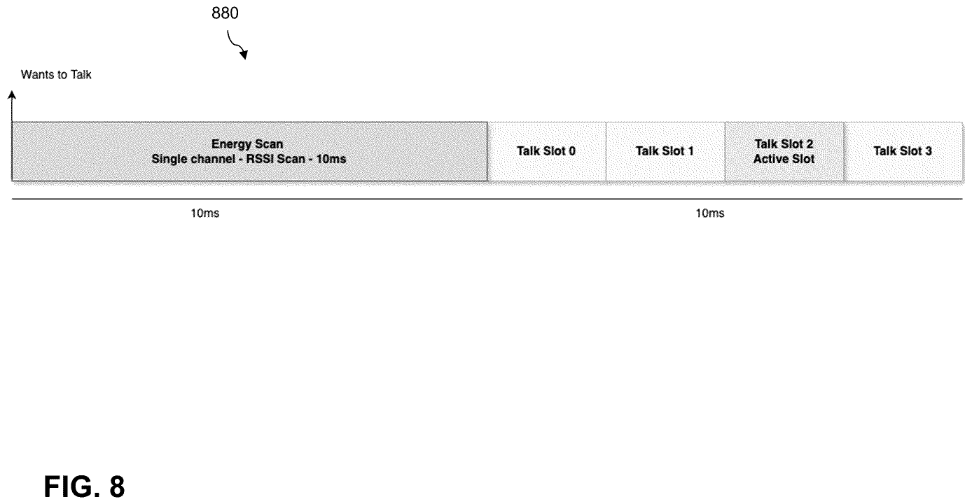

FIG. 8 shows a data transmission frame preceded by an energy scan frame in an example embodiment. By way of example, FIG. 8 depicts a structure illustration 880 depicting a data transmission frame wherein the four MAC layer talk slots are indicated as 0 through 3 and labeled within the beginning and ending PHY slots of each talk slot. In connection with the example embodiment depicted in FIG. 8, the actual transmitter is only active for two of the six PHY slots within a talk slot and NOT for the entire talk slot. Also, during the other talk slots in the frame that the node is not assigned to transmit in, the node schedules its PHY for a continuous receive operation in order to receive packets from the other potential talkers in the frame as well as the repeater. As such, FIG. 8 illustrates a higher level view of the data transmission frame and the four talk slots available for voice packet transmission.

Further, in such an example embodiment, the four talk slots in each frame can be used by nodes to transmit voice packet data in a TDMA fashion, wherein three talk slots are available for up to three different nodes on a subnet to simultaneously transmit voice packet data within the same frame. In one or more embodiments, obtaining access to the available talk slots can occur as a result of execution of a consensus-based fairness algorithm which provides competing talker nodes the ability to win talk slots in order to transmit their voice packets.

Also, the fourth talk slot in such a data transmission frame can be dedicated as a repeater slot for an elected dedicated repeater node when the MAV networking system is configured for operation in the mesh topology mode. A purpose of the fourth talk slot can be for the mesh topology-elected repeater to repeat the voice packet data from all three active talker nodes in the previous data transmission frame. Further, each active talker in a data transmission frame can act as a repeater node for talkers in the previous frame by repeating the packets from those talkers.

One or more embodiments also include configuring at least one MAV network system over-the-air (OTA) common data packet format. In such an embodiment, the MAV network system uses a common data packet format for sync packet, audio packet and/or repeater packet transmissions, and outgoing OTA packets are assembled by the MAV stack MAC and placed into a transmit queue referred to herein as “tx_buf,” while packets received from other nodes OTA are stored in a receive queue referred to herein as “rx_buf.” By way of illustration, Table 2 illustrates an example packet format.

TABLE 2

| Field | Size (Bytes) | Description |
|---|---|---|
| sync_64 | 8 | Sync packet consisting of transmitting node's 64-bit local |
| | | network time |
| conn | — | Mesh topology connection data structure |
| conn.graph | 4 | Transmitting node's current mesh topology connection |
| | | graph |
| conn.rptr_vote | 1 | Transmitting node's vote for the mesh repeater in the next |
| | | active transmission frame |
| conn.rsvd[3] | 3 | Reserved |
| audio[4] | — | Voice packet array data structure for 4 voice channels |
| audio.payload_type | 1 | Voice packet header payload type. Value of 0 indicates |
| | | a voice packet type encoded at a bit rate of 24 kbps |
| audio.origin_id | 1 | Voice packet header origin ID. Signifies the RadioID of |
| | | sender |
| audio.slot_number | 1 | Voice packet header slot number. Signifies the slot |
| | | number that the transmitter used for sending the data |
| | | packet |
| audio.seq_number | 1 | Voice packet header sequence number. Signifies the |
| | | sequence number for the packet within the overall |
| | | message |
| audio.payload_len | 1 | Voice packet payload length. Provides the length in bits |
| | | for the voice packet being sent |
| audio.payload[30] | 30 | Up to 30 bytes of encoded voice data consistent with the |
| | | payload type indicated in the header of the packet |
| TOTAL SIZE | 156 Bytes | |
| | (1,248 bits) | |

When defining the MAV network system packet structure, the system design must ensure M compatibility with limits imposed by the PHY. By way of illustration, in the case of an example DECT-2020 PHY, the lowest order modulation and coding scheme that provides enough capacity for the MAV network system's packet structure is MCS2. The choice of which MCS level to operate the PHY at can include a trade-off between communication range and throughput. In the case of the DECT-2020 PHY, MCS2 uses quadrature phase shift keying (QPSK) modulation. Higher-order modulations can be used as well because they will support higher packet capacities, but at the expense of some communication range.

Table 3 below illustrates the data capacity for an example DECT-2020 PHY at various MCS levels and transmission slot and/or sub-slot values. Also, the MAV network system can use two full PHY slots per a single talk slot which is used to transmit the common data Packet. In Table 3, the intersection of the MCS2 row and the second slot column (labeled as “slot 1”) provides a total bit capacity of 1,256 bits, which is sufficient capacity for transmission of the common data packet (i.e., a packet of 1,248 bits in size).

TABLE 3

| | slot | | | | | | | | | |
|---|---|---|---|---|---|---|---|---|---|---|
| | 0 | | 1 | | 2 | | 3 | | 4 | |
| sub-slot | 0 | 1 | 2 | 3 | 4 | 5 | 6 | 7 | 8 | 9 |
| MCS0 | 0 | 136 | 264 | 400 | 536 | 664 | 792 | 920 | 1064 | 1192 |
| MCS1 | 32 | 296 | 552 | 824 | 1096 | 1352 | 1608 | 1864 | 2104 | 2360 |
| MCS2 | 56 | 456 | 856 | 1256 | 1640 | 2024 | 2360 | 2744 | 3192 | 3576 |
| MCS3 | 88 | 616 | 1128 | 1672 | 2168 | 2680 | 3192 | 3704 | 4256 | 4768 |
| MCS4 | 144 | 936 | 1736 | 2488 | 3256 | 4024 | 4832 | 5600 | 6408 | 7176 |

It is noted that the use of a common data format packet can result in retransmissions of certain data fields for various data frame types. For example, sync_64 sync packet transmissions can represent the primary data structure sent during sync frames to maintain network synchronization during network IDLE times. However, the sync_64 information is sent during every transmission in order to enhance synchronization during periods of active voice conversations across the network. Similarly, even though a mesh topology uses a dedicated repeater frame, each talker always retransmits and/or repeats the voice packets from the other talkers (if any) in the previous frame in addition to the repeated transmission from the dedicated repeater. This retransmission of redundant information can enhance the reliability of the overall network and help to maintain tight timing synchronization across the network, which can be especially important, for example, when users are mobile and the network topology is constantly changing. Data packet contents, in accordance with one or more embodiments, are further described below.

For example, in such an embodiment at least one data packet includes a sync field structure field (referred to herein in connection with one or more embodiments as sync_64). This field is considered the node's sync packet, and the field contains the transmitting node's 64-bit MAC time, which can be considered the node's local network time. By way of illustration, in an example embodiment, the resolution of the LSB is 250 nanoseconds (ns), and sync packet information is exchanged via the common data packet during subnet IDLE time via the 640 ms sync interval. In addition, every time a device transmits their voice packet or repeats another device's voice packet, the device includes their latest sync packet as part of the common data packet.

One or more embodiments also include implementing a connection graph and repeater structure field (referred to herein in connection with such an embodiment as conn.graph). This field represents the transmitting node's connection graph, wherein a node's connection graph is created and maintained by receiving connection graphs from other connected nodes on a subnet. In an example embodiment, every node transmits their most recent connection graph at a minimum of once every 640 ms during a sync interval. The graph, in such an embodiment, is 32-bits wide and each bit represents one of the possible 32 nodes that the subnet can support. Nodes transmitting their voice packet data also share connection graphs with repeater votes in every frame in which they transmit. Creation, maintenance and use of such graphs are further described herein.

At least one embodiment also includes implementing a conn.rptr_vote field, which represents a transmitting node's vote for the most optimum repeater node to repeat its packet in the next active frame, wherein an active frame is defined to be a frame that a node has determined to be clear to transmit in after performing an energy scan in the previous frame before the active frame. The transmitting node makes this determination from mesh network topology connection information that the node has assembled in its most recent update of its connection graph.

In such an embodiment, all transmitting nodes in a given frame share their connection graphs along with their repeater votes in the transmitted common data packet. Also, all listening nodes within range of the transmitting nodes then use these votes to determine if they have been elected as the repeater in the next active frame. Repeater voting and election of repeaters is further described herein.

Additionally, one or more embodiments include implementing a voice data array structure field. The OTA common data packet can allocate space, for example, for four individual voice and/or audio packets, including their header information fields and specified by the “audio[4]” field. These four voice packet memory array locations are used by each node to store the header information and encoded voice sample data for both a voice packet that a node will transmit over the air, as well as for voice packets received by other nodes to play back the voice data to a user. In such an example embodiment, the packets received from the other nodes are also repeated over the air two frames after being received, along with repeater packets from the dedicated repeater node as part of the corresponding mesh topology.

Header information affiliated with each voice packet instructs receivers as to how to handle the received packets. In one or more embodiments, such header fields can include, for example, audio.payload_type, audio.origin_id, audio.slot_number, audio.seq_number, audio.payload_len, and audio.payload. More particularly, in such an embodiment, audio.payload_type represents an 8-bit field that is part of the voice packet header that signifies the type of data contained within the data payload portion of the packet. Payload types defined by the MAV network stack protocol, along with their corresponding type values, can include, for example, the following: Audio Packet: 0x00, wherein the payload comprises voice and other types of audio information; Sync Packet: 0x02, wherein the payload comprises sync packet information; Audio Repeater Packet: 0x7F, wherein the payload is a repeated audio packet transmitted by a repeater; Audio RPT Packet: 0x80, wherein the payload is a repeated audio packet transmitted by a transmitter; and Unknown Type: 0xFE, wherein the packet is an unknown type.

Also, audio.origin_id represents an 8-bit field that signifies the device ID of the original source node (i.e., the original transmitting node or talker). Note that for nodes that are transmitting as a repeater, the audio.origin_id will be the original source node device ID, and not the device ID of the repeater. Further, audio.slot_number represents an 8-bit field that signifies the MAC talk slot in which the voice packet is transmitted, and audio.seq_number represents an 8-bit field that signifies the voice packet sequence number as part of the overall voice message that is used by receiving nodes to reconstruct voice messages from received voice packets.

Additionally, audio.payload_len represents the payload length expressed as an 8-bit field as part of the voice packet header for specifying up to a maximum of a 256-byte voice packet, and audio.payload represents the actual voice sample data packet including up to 30-bytes of voice data in an example implementation of the MAV network stack. Note that, in one or more embodiments, outgoing voice samples to be transmitted over the air can be encrypted with AES-256 encryption using pre-configured security credentials. In such an embodiment, encryption occurs on only the voice data and takes place prior to transmission. Inbound voice payload data will be decrypted after leaving the MAV network stack MAC and bound for the voice processing platform in the thin upper layer. Voice traffic encryption is also further discussed herein.

One or more of the following tables and description related thereto provide different scenarios as to how the voice data array is used by nodes in the MAV networking system for reception, transmission and repeating of voice packet data over the network.

A first scenario, pertaining to a direct mode (no mesh) 1-talker case, is described below in connection with Table 4. In this case, the mesh topology feature is disabled and a single talker node is transmitting voice data across the subnet. Note that Table 4 shows the four audio channels contained within the packet structure, as well as the physical transmit and receive buffers along with the frame time related to the audio samples stored within them at the given time.

As can be seen from Table 4, in this example a packet of encoded and encrypted outgoing voice data (originating from the speech of the user of a device implementing one or more embodiments of the invention) is queued up in the audio[0] channel of the voice packet stored in the node's transmit buffer. This packet is to be transmitted in the current frame N during the node's assigned Talk Slot 1. Since there are no other nodes communicating on the subnet, the remaining audio channels in the transmit buffer and all receive buffer audio channel storage is empty. It should be noted that audio channel 0 (i.e., audio[0]) is reserved for the direct, original packet transmissions of talking nodes. The remaining three audio channels are used for repeating audio packets either by a dedicated repeater node, or by any talker node repeating received audio packets from other talkers.

A second scenario, pertaining to a direct mode (no mesh) 2-talker case, is described below in connection with Table 5. This case adds another talker to the subnet from the first scenario detailed above.

Building on the first scenario, in this second scenario, Talker C emerges and is assigned to talk in Talk Slot 3. Both Talker A and Talker C store their outgoing voice transmissions in the audio[0] channel of their voice packet array for transmission in the next frame N. As noted above, nodes always store their own outgoing voice transmission packets in the audio[0] channel of their voice packet array, and this implies that in order to repeat packets from other nodes, a node preparing to transmit its own voice packet that is being queued up in its transmit buffer must take the audio[0] channel from a voice packet stored earlier within the node's receive buffer and move it to the node's transmit buffer at another audio array channel location in order to repeat the remote node's original transmission. This transfer from receive to transmit buffers is indicated in Table 5. The retransmitted packet from the remote node can be placed in any one of audio channels [1], [2] or [3], depending upon availability, as these channels are where repeated packets are stored for transmission.

This second scenario also assumes that both nodes were also talking two frames earlier during frame N−2 when each opposite node received the other node's transmitted packet and stored it in a receive buffer. While a purpose of receiving these voice packets is to reassemble an entire voice message, decrypt and decode the audio, and then send it to the user to hear, each node also repeats received OTA packets along with their own original OTA audio transmissions two frames after they are received, regardless of whether or not the mesh topology is enabled. In other words, in such an example embodiment, as long as there are two or three nodes talking during a given frame, there is a meshing effect happening that has a limited ability to extend range and improve communication robustness even when the mesh topology is disabled.

Repeating an OTA audio packet can require two frames (~20 ms) from the time it is received until the time it is repeated over the air. If a node originally transmits a packet in frame N−2, the receiving node cannot repeat the packet in the next frame N−1 because transmit operations for the next frame have already been queued up for execution by the PHY. Thus, the node must repeat the received packet in frame N. In one or more embodiments, this two frame packet repeat latency is present at all times regardless of whether or not the mesh topology is enabled.

A third scenario, pertaining to a direct mode (no mesh) 4-talker case, is described below in connection with Table 6. In one or more embodiments implementing mesh topology, the protocol provides a dedicated repeater slot so that in a scenario of only one talker node, that node's voice data is always repeated provided that the repeater node is in range. When mesh is disabled, the dedicated repeater slot is available for a fourth simultaneous talker. The third scenario, detailed below in Table 6, illustrates a fully subscribed subnet with the four simultaneous talkers.

The entries for Talker A show both the transmit buffer and the multiple receive buffers handling audio packets from Talker B, Talker C and Talker D. Table entries for Talker B, Talker C and Talker D only show their transmit buffers during frame N−2, which corresponds to the frame time shown for Talkers A's receive buffer (i.e., Talker's, Talker C's and Talker D's transmissions during frame N−2 are read by Talker A and placed in the node's receive buffer for the same frame time). While detail for the receive buffers is not shown for Talker B, Talker C and Talker D, they behave in the same manner as for Talker A.

Other than illustrating the simultaneous transmissions within a frame time for four talkers, another aspect of what is shown in this third scenario is the use of the audio channel [0] voice packets from the remote nodes, and how the local node places their audio[0] packets into channels [1], [2] and [3] for repeating the audio data. It is also noteworthy to point out that the two frame packet repeat latency discussed above is illustrated for five frames in Table 6. During frame N−2, transmissions by Talker B, Talker C and Talker D of the repeated packets are indicated as “Pkt 1.” Then, for Talker A's repeated packets during Frame N, these are shown as “Pkt 3”. Finally, Talker A's original transmission during frame N is shown as “Pkt 5”. In such an example embodiment, this assumes that all four nodes began their “Pkt 1” transmissions during frame N−5.

A fourth scenario, pertaining to a mesh topology mode 2-talker plus repeater case, is described below in connection with Table 7. This fourth scenario illustrates the manner in which the audio channel arrays are used in conjunction with the receive and transmit buffers in the mesh topology mode, with the introduction of a dedicated repeater in Talk Slot 4.

The Talker A and Talker C operations continue in the same manner as the non-mesh case(s) detailed above, but the repeater behaves differently in this fourth scenario. Note that the repeater does not use its audio[0] voice packet array location, and the node(s) elected as the repeater within a frame only transmit repeated data in audio channels [1], [2], and [3]. However, because any node can be elected as the repeater in a given frame, the node can also behave as a non-repeater node when it is not the elected repeater. As used herein in connection with one or more embodiments, the term “dedicated” repeater does not imply that the same node is always the repeater, but rather that there is a dedicated repeater function operating on the subnet at all times when mesh topology mode is enabled. A difference between mesh topology mode and non-mesh direct mode is that the repeater is always present to repeat every talker's transmissions in mesh topology mode, whereas in non-Mesh mode there has to be active talkers transmitting for voice packet repetition. Further, as previously noted, if there is only one talker in the non-nesh topology, there is no packet repeat.

A fifth scenario, pertaining to a mesh topology mode 3-talker plus repeater case, is described below in connection with Table 8. This fifth scenario illustrates voice packet array usage in a fully subscribed MAV network system in mesh topology mode with three active talkers and a dedicated repeater occupying all available talk slots.

Also, as further detailed herein, one or more embodiments include implementing network synchronization, as well as timing corrections and alignment(s). In such an embodiment, achieving initial timing synchronization between active nodes on a MAV networking system subnet, and maintaining that synchronization and compensating and/or correcting for internal node asynchronous time bases are essential for reliable subnet communications. Accordingly, and as further detailed below, at least one embodiment includes implementing techniques to address timing and synchronization challenges within a network node itself, as well as synchronizing and maintaining that timing amongst a large number of nodes spanning across an entire mesh subnet without the benefit of a central base station, access point and/or other network controller. Regarding the latter case of network synchronization, the concept of a universal MAC time across all nodes is introduced and described in connection with at least one example embodiment.

As further detailed herein, one or more embodiments include implementing internal node timing and synchronization. By way of example, in implementation of the MAV stack for a given PHY transceiver, it may be reasonable to expect that asynchronous time bases are encountered within a node between a third party semiconductor PHY layer and MAV stack layers above the PHY. In order for the MAV stack to function properly when integrated with the third party PHY, sources of time base misalignment must be correctly compensated for. Potential sources of this misalignment can include, for example, differences in time base timer resolutions, offsets due to differences in startup conditions, drift between the two time bases, callback delays in accessing timestamps across the PHY-MAC layer interface boundaries, etc.

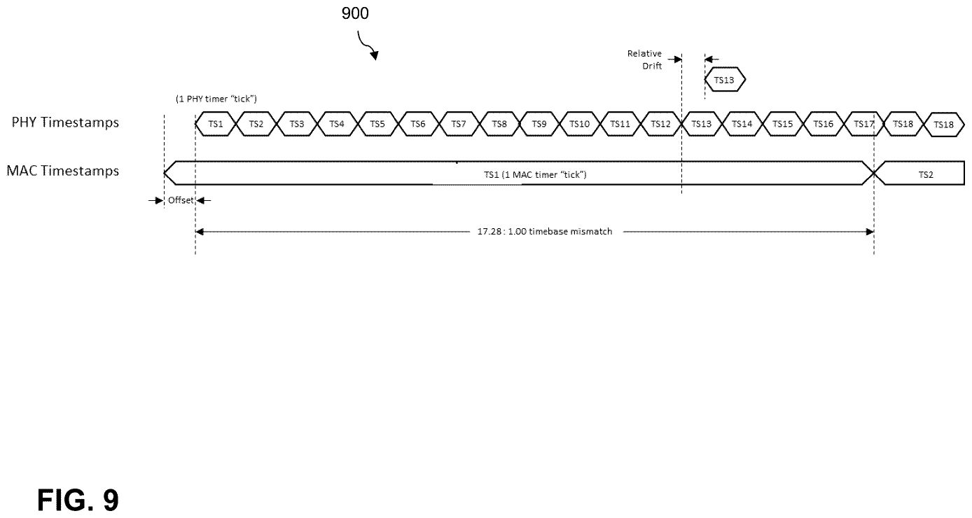

FIG. 9 shows an overview of PHY and MAC time base error sources in an example embodiment. By way of example, FIG. 9 illustrates a graphical depiction 900 of the first three of the above-noted error sources (i.e., differences in time-base timer resolutions, offsets due to differences in startup conditions, and drift between the two time bases over time) resulting in PHY-MAC time base misalignment.

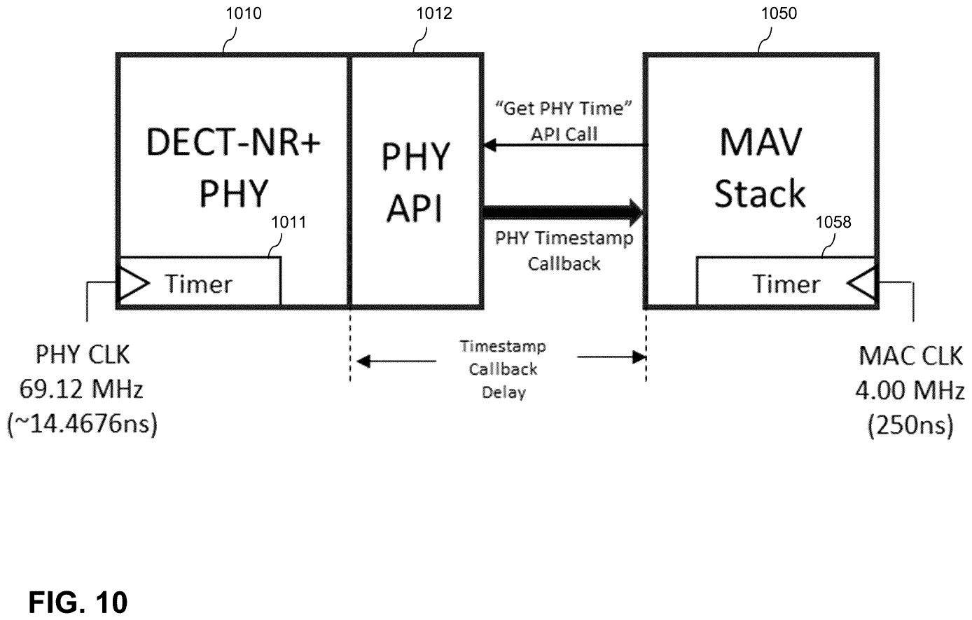

FIG. 10 shows an illustration of a PHY get time callback delay in an example embodiment. By way of illustration, FIG. 10 depicts a high level diagram of a delay imposed relative to the PHY timestamp actually received due to processing delays between the DECT-NR+ PHY 1010, which includes timer 1011, sending the timestamp via PHY application programming interface (API) 1012 in the callback, and the MAV stack 1050, which includes timer 1058, recognizing reception of the timestamp from the DECT-NR+ PHY 1010 to illustrate how the fourth above-noted error source (i.e., callback delays in accessing timestamps across the PHY-MAC layer interface boundaries) is introduced.

One or more embodiments can also include implementing internal node time bases. By way of illustration, as depicted in the example embodiment of FIG. 10, the DECT-NR+ PHY 1010 uses a reference clock source of 69.12 megahertz (MHz) with a corresponding resolution of 14.4676 ns in order to derive the proper PHY slot timing required by the corresponding PHY specification. From this clock frequency, the required DECT-NR+ PHY 1010 slot period of 416.667 microseconds (us) (which can also be represented in this example embodiment as 28,800 reference clock periods) produces a 10 ms communication frame with 24 PHY slots. The PHY API 1012 available to the MAV stack 1050 does not provide any form of direct reference signal that can be used for purposes of synchronization. Further, there is no immediate way to access the PHY reference clock from the MAV stack 1050, nor is there a way to modify its time value. In such an example embodiment, the only time reference access provided by the PHY is via an API call to obtain a 64-bit timestamp value via a “time_get” callback, and the resolution of the timestamp is 14.4676 ns. This callback is under software control and will have an unspecified delay associated with it. The PHY reference clock source is also referred to herein as the PHY timer, and 64-bit timestamps received by the MAC from the PHY via a “time_get” callback are also referred to herein as “phytime.”

The MAV stack embodiment used in conjunction with the DECT-2020 PHY and/or DECT-NR+ PHY operates with a 4 MHz reference clock source with a corresponding resolution of 250 ns and operates asynchronously with respect to the PHY reference clock. The MAV stack time reference is also referred to herein as the MAC timer with the current value of the timer referred to as “mactime.” The MAC timer, in one or more embodiments, includes one or more of the following characteristics. The timer itself is 32-bits with an LSB resolution of 250 ns, channel 0 is used to access the timer value when captured with a function call, and channel 1 is initialized as a 32-bit timer compare register and used to generate an interrupt whenever the 32-bit timer rolls over from its terminal count of 0xFFFFFFFF. This interrupt is used to increment a 32-bit variable referred to herein as “upper32,” wherein upper32 represents the upper 32-bits of the 64-bit “mactime.” The 64-bit quantity is formed by concatenating the current value of the Channel 0 counter (e.g., the lower 32-bits) with “upper32.” Once initialized, the Channel 1 timer compare register is never modified. Channel 2 is also initialized as a 32-bit timer compare register, and its initial value is 40,000 MAC timer ticks, which represents a value of 10 ms. The timer is configured to generate a Channel 2 interrupt when this count is reached. Also, the Channel 2 interrupt generated whenever the value stored in this compare register is reached represents a start-of-frame (SOF) interrupt and is a critical time reference within each node of the MAV networking system. The Channel 2 compare register is updated once every frame with the timestamp of the expected next SOF. Also, adjustments can be made to the value in the Channel 2 compare register to accommodate certain timing corrections determined within the operation of the MAV stack.

At least one embodiment also includes determining PHY-MAC time base error sources and corrections. As detailed below, the following paragraphs provide sources for PHY-MAC timing misalignment, resulting in synchronization errors if not accounted for and corrected. Note that while each of these is discussed individually, the errors can be additive, and in such instances, the corrections must be applied together.

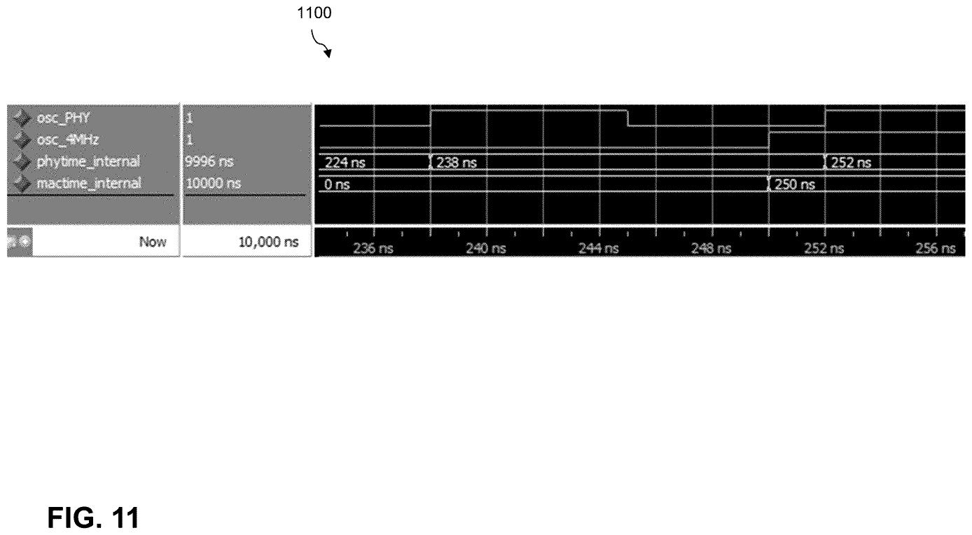

One such source includes resolution variance errors. More particularly, a source of timestamp errors between the PHY and MAC can be due to the difference in timer resolutions. This error source can be exasperated because their relative resolutions do not have an integer relationship, and the result of this error source is illustrated in FIG. 11.

FIG. 11 shows a PHY-MAC time base resolution error in an example embodiment. By way of illustration, FIG. 11 depicts a graphical illustration 1100 depicting a result of a resolution variance error source. More particularly, “osc_PHY” represents the 69.12 MHz PHY timer clock, and “phytime_internal” represents “phytime” timestamps. Also, “osc_4 MHz” represents the MAC timer clock and “mactime internal” represents “mactime” timestamps. This scenario models both clocks starting without an offset between them. The error is evident in the difference between the timestamp values and results from a combination of the difference in resolution as well as the non-integer relationship between the clock periods. The higher frequency PHY clock's timestamps indicate time more accurately than the slower MAC timer, and the fractional relationship results in additional misalignment.

This situation requires that timestamps shared across the PHY-MAC interface must be corrected for this misalignment. In specific terms, each tick of the MAC timer represents approximately 17.28 ticks of the PHY timer. Accordingly, the MAV stack applies this correction factor whenever converting timestamp values from one time domain to the other using MAC-to-PHY and PHY-to-MAC conversion algorithms. As an example, the MAC schedules transmit, receive, and other operations for the PHY to execute at a specific “phytime” over-the-air. In each case, a time-of-execution timestamp must be provided to the PHY. In order to do this, the MAC must convert the timestamp from its mactime time base into phytime using the MAC-to-PHY conversion routine. Conversely, for API callbacks provided by the PHY upon execution of an operation commanded by the MAC, any callback that contains a PHY timestamp must be converted into mactime for the MAC to make use of.

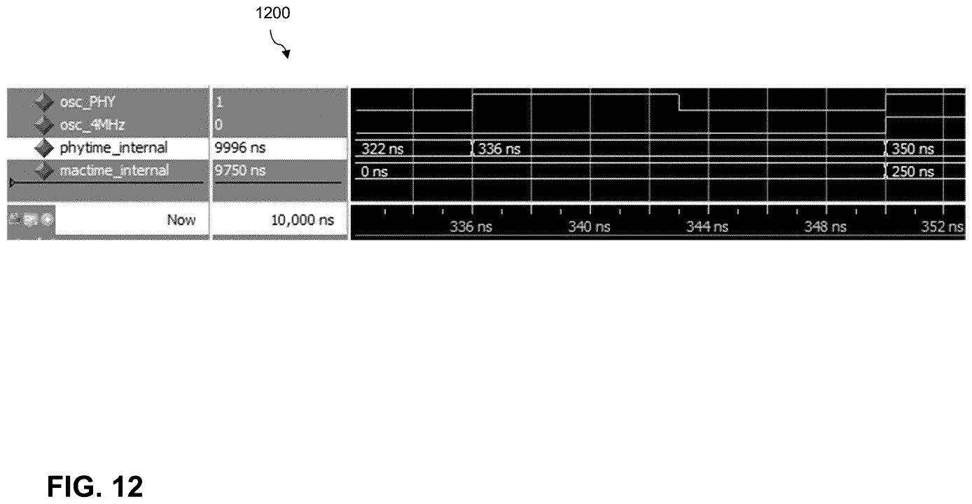

Also, because there is no guarantee that the PHY time base begins its timekeeping at exactly the same time that the MAV stack time base starts tracking time, there is a need to determine the offset between the two. The offset error is illustrated in FIG. 12.

FIG. 12 shows a PHY-MAC time base offset error in an example embodiment. By way of example, FIG. 12 depicts a graphical illustration 1200 depicting an offset error source. In such an embodiment, a 100 ns offset is introduced on the MAC clock with respect to the PHY clock. Any initial offset between the two time bases will show up in the timestamps produced within the two time domains. This initial PHY-MAC time base offset is initially measured in a PHY sync process and the offset is used to align subsequent PHY timestamp retrievals by the MAC, as further detailed herein.

In one or more embodiments, the two time bases can drift apart in time with respect to each other over some period of time. The drift is exasperated further when modifications are made to operation of the MAC timer (e.g., the time is paused or cleared), including synchronization of a local MAV network node with another remote MAV network node. Regardless of the cause of the drift, it must be tracked and compensated for in any timing related operations between the PHY and MAC. Drift between the time bases is periodically corrected as further described herein.

One or more embodiments can include processing a PHY timestamp API call—callback delay error. When the MAC makes an API call to get a timestamp of the current time from the PHY, the timestamp is captured in the PHY and provided to the MAC via a callback routine. By the time the MAC receives the timestamp in the callback, a certain amount of time has elapsed and the PHY timestamp does not reflect this elapsed time. The callback delay is another correction factor that must be applied by the MAC for any timestamps requested of the PHY to obtain phytime. For the MAV stack coupled to the example DECT-2020 PHY, this callback delay has been empirically determined to be on the order of 38.151 ms. This callback delay correction factor is initially applied when the MAC is initialized, and on an ongoing basis whenever a new PHY timestamp is requested by the MAC.

Additionally, at least one embodiment includes maintaining internal node PHY-MAC synchronization. As described herein, such an embodiment includes determining the actual correction, alignment and synchronization process to initially align the two time bases and to periodically keep them aligned. Also, it is noted that while these corrections can be imperative to proper operation of the MAV stack, there is limited flexibility in the actual timer mechanisms themselves in terms of correction. For the PHY timer, typically nothing can be done. On the MAC side of the interface, the primary correction is adjusting the SOF interrupt timing for the next frame interrupt.

When a MAV network node is powered up, it begins its boot-up and initialization. As part of the MAC initialization process, the node performs the first “time_get” API call to get a timestamp from the DECT-2020 modem to determine the initial PHY-MAC time base offset. As further detailed herein, steps can be taken at this phase in node operation to calculate the initial offset between the PHY and MAC time bases that must be compensated for as part of the alignment process.

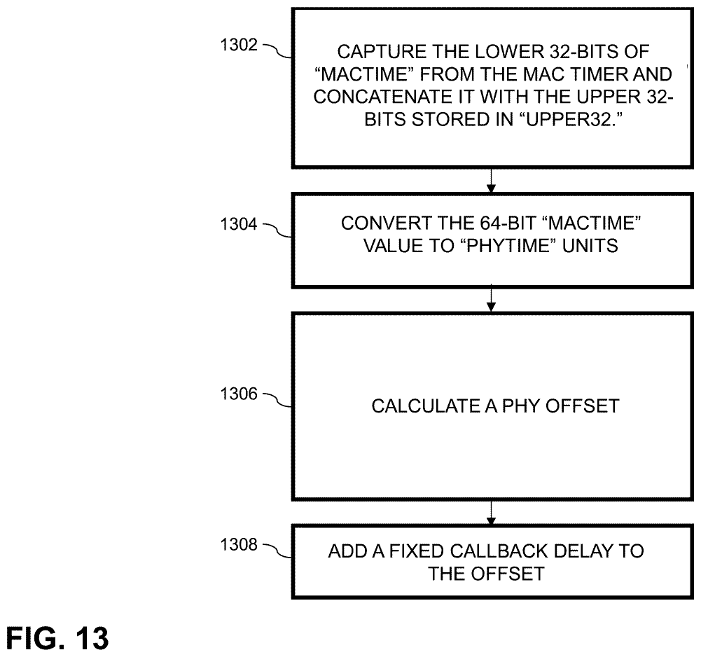

FIG. 13 shows an initial PHY-MAC offset determination workflow in an example embodiment. By way of example, as depicted in FIG. 13, step 1302 includes capturing the lower 32-bits of “mactime” from the MAC timer and concatenate it with the upper 32-bits stored in “upper32.” More particularly, capturing and concatenating the lower 32-bits of “mactime” from the MAC timer can include adding “mactime.offset” to the “mactime” (wherein the offset equals zero during initialization), and storing the result in an “mactime” variable.

Also, step 1304 includes converting the 64-bit “mactime” value to “phytime” units, for example, by multiplying the value by a 17.28 MAC-to-PHY conversion factor (i.e., 69.12 MHz/4 MHz). Step 1306 includes calculating a PHY offset. More particularly, calculating a PHY offset can include the MAC calling the PHY “time_get” API to obtain the PHY timestamp. Once both time values are in “phytime” units, “mactime” is subtracted from “phytime” to determine the offset. Further, step 1308 includes adding a fixed callback delay to the offset. More particularly, at least one embodiment includes adding an empirically-determined fixed callback delay of 38.151 microseconds to complete the offset calculation. The result is then saved in the “phy_offset” variable for use in the periodic PHY-MAC time synchronization, as further described herein.

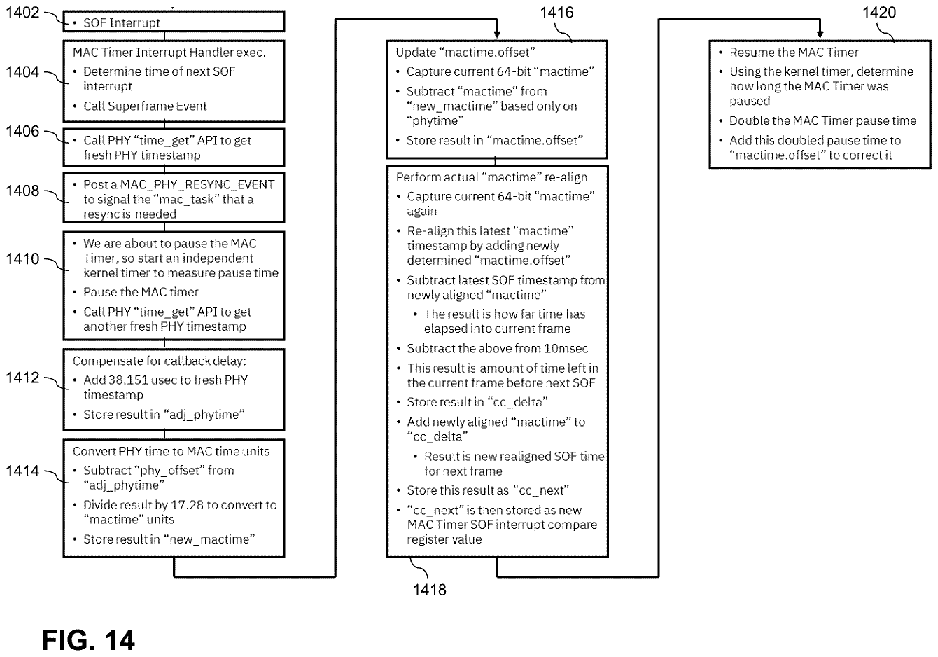

Additionally, the PHY-MAC synchronization process described below in connection with one or more embodiments can occur on a periodic basis referred to as a superframe event. The superframe event executes at the beginning of every new frame (e.g., at the SOF). The SOF boundary is signified by a SOF interrupt as further described herein. At the beginning of the execution of the superframe event, an API call is made to obtain a fresh timestamp from the PHY. When the PHY “time_get” callback is received with the new PHY timestamp, a PHY-MAC resync process is triggered. Because a superframe event occurs at the beginning of every frame time, e.g., which can be nominally every 10 ms), the PHY-MAC is being re-synchronized every 10 ms as well. FIG. 14 below illustrates the steps involved to conduct the resynchronization (resync).

FIG. 14 shows a PHY-MAC time base resync workflow in an example embodiment. By way of illustration in FIG. 14, and as further detailed below, a result of this example workflow is to update the “mactime.offset” variable, which is used to modify the timestamp to the next SOF. In one or more embodiments, the periodic adjustment of the 64-bit value contained within “mactime.offset” is a primary mechanism for applying all of the node timing corrections, adjustments and alignments.

In connection with converting PHY time to MAC time units, one or more embodiments include utilizing a SOF interrupt 1402 and a MAC timer interrupt handler 1404 to determine the time of the next SOF interrupt and to call at least one superframe event. Such an embodiment also includes, in step 1406, calling a PHY “time_get” API to obtain a fresh and/or new PHY timestamp, and posting, in step 1408, a MAC_PHY_RESYNC_EVENT to signal the “mac_task” that a resync is needed. Also, step 1410 includes starting an independent kernel timer to measure the pause time for pausing the MAC timer, then pausing the MAC timer and calling the PHY “time_get” API to obtain another fresh and/or new PHY timestamp. Additionally, step 1412 includes compensating for a callback delay by adding 38.151 microseconds to the fresh and/or new PHY timestamp, and storing the results as the “adj_phytime” variable/value. Further, step 1414 includes converting the PHY time to MAC time units by subtracting the “phy_offset” from the “adj_phytime” value, dividing the result by 17.28 to convert to “mactime” units, and storing the results as the “new_mactime” variable/value.

In connection with performing “mactime” realignment, step 1416 includes updating the “mactime.offset” variable/value by capturing the current 64-bit “mactime,” subtracting the “mactime” from the “new_mactime” based on the “phytime,” and storing the result as the “mactime.offset” variable/value. Additionally, step 1418 includes performing the “mactime” realignment by capturing the current 64-bit “mactime” again, realigning this latest “mactime” timestamp by adding the newly-determined “mactime.offset,” and subtracting the latest SOF timestamp from the newly-aligned “mactime” (wherein the result will indicate how much time has elapsed into the current frame). Step 1418 also includes subtracting the above resulting value from 10 ms, and this result will indicate the amount of time left in the current frame before the next SOF, and can be stored as the “cc_delta” variable/value. Additionally, step 1418 includes adding the newly-aligned “mactime” to the “cc_delta” variable/value, wherein the result is a newly realigned SOF time for the next frame, which can be stored as the “cc_next” variable value. Further, step 1418 storing the “cc_next” variable/value as the new MAC timer SOF interrupt compare register value.

In connection with updating the “mactime.offset” variable/value, step 1420 includes resuming the MAC timer, and using the kernel time to determine how long the MAC timer was paused. Additionally, step 1420 includes doubling the MAC timer pause time, and adding this doubled pause time to the “mactime_offset” variable/value to update and/or correct the “mactime_offset” variable/value.

In accordance with at least one example embodiment, there is no way to modify the PHY timer in a DECT-2020 modem. Also, in such an example embodiment, the MAC timer itself is never updated with a new 64-bit MAC time. Instead, the “mactime.offset” contains the necessary timing offset at any given point in time that gets added to the current MAC SOF time to adjust timing accordingly. The use of a single compensation factor applied to the start of every communication frame enables the existence of a “universal MAC time” or “network time” that can be tracked and aligned amongst all of the nodes on a subnet with the primary correction being to align frames on a continual basis, with each node using their calculated “mactime.offset” to apply their own unique correction factor to their “mactime” to arrive at the “universal MAC time” which must be maintained within, e.g., 100 microseconds or less, between all network nodes for proper operation and communication reliability. A process of nodes sharing their timing information with each other (i.e., sharing their “sync packets”) and how they achieve continual timing correction and alignment across a subnet is further detailed herein.

As also detailed herein, one or more embodiments includes implementing MAV network timing and synchronization. When a MAV networking system node powers up, there is no “always on” fixed infrastructure such as a base station or access point that is transmitting a beacon or pilot signal to easily find and obtain network time from for the purposes of synchronizing itself to an existing network. Instead, MAV network nodes forming a subnet after power-up must go through a discovery process to find other each other, and then go through a mutual synchronization process to establish a universal MAC time or network time before they can communicate with each other. Similarly, for the case wherein several nodes are already communicating over a subnet, when a new node enters the range of this subnet or powers up in the presence of the subnet, the new node goes through the same discovery and synchronization process to sync-up with the network time already established by the other nodes. Once two or more nodes have initially synchronized to this universal network time, they require periodic resynchronization due to drift in timing between the nodes.

As noted herein, in one or more embodiments, each connected node on a subnet executes its own identical copy of the MAV networking stack. Also, in such an embodiment, the MAC within the DLL in each node contains an FSM which maintains the proper sync state of the node, and is a contributing factor in maintaining timing and synchronization of each node across the subnet and in controlling execution of the networking system protocol. The protocol provides for a continuous sharing of each node's local network time with all other nodes on the subnet. Additionally, a consensus based algorithm can be used amongst the nodes to decide which node's version of their local time to use for correction of all node's local time, resulting in a continuously synchronized virtual “network time” across the subnet.

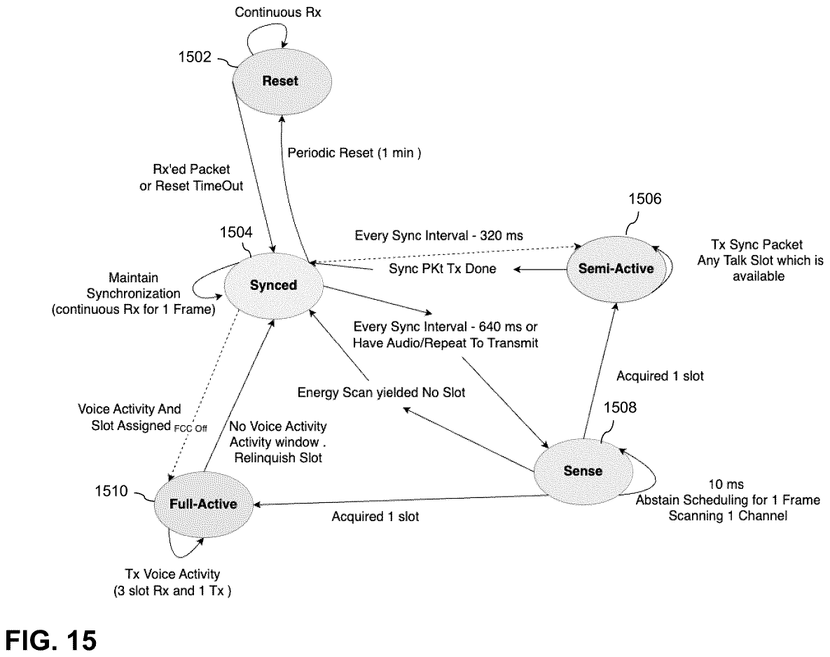

FIG. 15 shows a MAC sync state FSM in an example embodiment. By way of example, and as depicted in FIG. 15, after a node powers-up and initializes itself, its MAC sync state FSM is in the RESET state 1502. After initialization of both the PHY and the MAC, the timers for both entities are operational, as well as the MAC's 10 millisecond frame timer to mark SOF boundaries. In one or more embodiments, the MAC sync state FSM RESET state 1502 is used by a node to initially achieve synchronization with other nodes on a subnet and to completely resynchronize itself under certain error conditions. Upon powering up or entering the range of an existing subnet prior to joining, the node has no awareness of any other MAV networking system nodes that may already be operating on an in-range subnet. As such, the node has no awareness of network protocol frame or slot timing. Therefore, in the RESET state 1502, the MAC causes the PHY to operate in a continuous receive mode to search for a compatible PHY signal from another node and attempt to receive and demodulate the other node's preamble (in the example DECT-2020 PHY, this preamble is referred to as the synchronization training field (STF)). Note that the subject node has previously been provisioned to operate on a particular RF carrier frequency and with certain other provisioning parameters that must match any other node it is searching for as a prerequisite for discovering other nodes on the subnet. Upon discovering one or more other nodes, proper reception and demodulation of the STF from such nodes enables the receiving node to adjust its receiver gain, timing and frequency for initial signal acquisition.

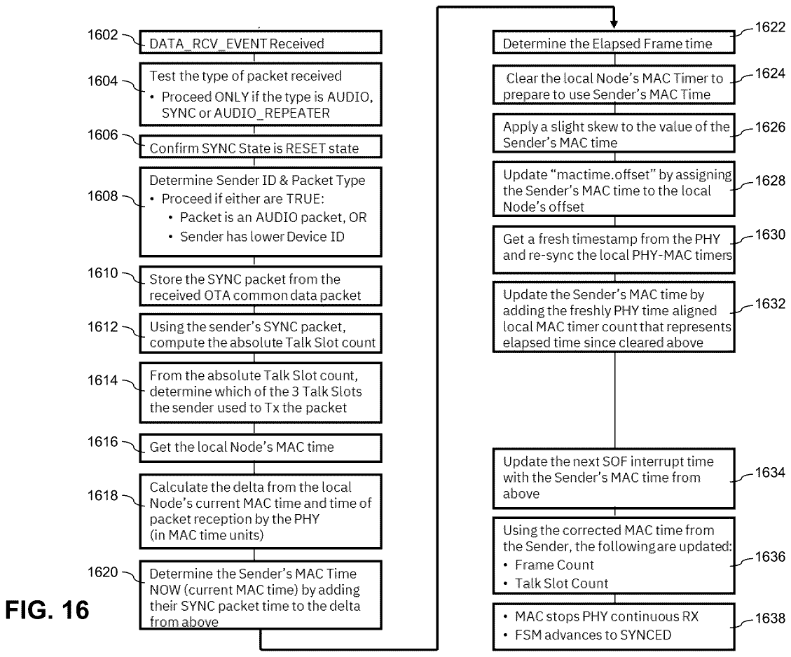

At entry into the RESET state 1502, the MAC provides the PHY with the duration of the continuous receive operation (e.g., approximately one minute). While in the RESET state 1502, the node's MAC is waiting for the reception of at least one valid packet transmission from another node, as indicated by a DATA RECEIVE EVENT API callback from the PHY. If, for example, after one minute of waiting without receiving anything, the node will leave the RESET state 1502 and enter the SYNCED state 1504. Alternatively, if a packet is received before the one minute period elapses, the node will also leave the RESET state 1502 and enter the SYNCED state 1504. However, even though both situations result in a state transition to the SYNCED state 1504, in the case of a received packet, timing related processing takes place as the local node is able to receive the transmitting node's timing information in the SYNC packet portion of the received common data packet. The synchronization-related algorithm using the other node's timing information in the RESET state 1502 is further detailed in connection with FIG. 16 below.

FIG. 16 shows a workflow related to implementing network synchronization in the RESET state in an example embodiment. As depicted in FIG. 16, one or more embodiments include determining a sender's current MAC time, and step using the sender's current MAC time to update the frame count, update the talk slot count, and advance the FSM to SYNCED. In connection with determining a sender's current MAC time, step 1602 includes receiving a DATA_RCV_EVENT signal, and step 1604 includes testing the signal for the type of packet received, proceeding only if the type of packet received is AUDIO.SYNC or AUDIO_REPEATER. Also, step 1606 includes confirming that the SYNC state is a RESET state, while step 1608 includes determining the sender device ID and proceeding if the packet is an AUDIO packet or if the sender device ID is lower than a designated value. Additionally, step 1610 includes storing the SYNC packet from the received OTA communication data packet, and step 1612 includes using the sender's SYNC packet to compute the absolute talk slot count. Further, step 1614 includes using this absolute talk slot count to determine which of the three talk slots the sender used to transmit the packet. Also, step 1616 includes obtaining the local node's MAC time, step 1618 includes calculating the delta from the local node's current MAC time and the time of the packet reception by the PHY (in MAC time units), and step 1620 includes determining the sender's current MAC time by adding the sender's SYNC packet time to the calculated delta.

In connection with using the sender's current MAC time to update the frame count, update the talk slot count, and advance the FSM to SYNCED, step 1622 includes determining the elapsed frame time based at least in part on the determined sender's current MAC time. Step 1624 includes clearing the local node's MAC timer to prepare to use the sender's MAC time, step 1626 includes applying a skew and/or adjustment to the value of the sender's MAC time, and step 1628 includes updating the “mactime.offset” by assigning the sender's MAC time to the local node's offset. Additionally, step 1630 includes obtaining a fresh and/or new timestamp from the PHY, and resynchronizing the local PHY-MAC timers. Step 1632 includes updating the sender's MAC time by adding the newly PHY time-aligned local MAC timer count that represents the elapsed time since cleared (as above). Further, step 1634 includes updating the next SOF interrupt time with the sender's MAC time, step 1636 includes using the corrected MAC time from the sender to update the frame count and the talk slot count, and step 1638 includes using the MAC to stop the PHY continuous receipt action(s), and advancing the FSM to SYNCED.

By way of example, in following the process described above in connection with FIG. 15, a result of the workflow of FIG. 16 is that the local node that has been in the RESET state is now synchronized to the remote node because it's next SOF timestamp is based on the remote node's MAC time, which can be considered the “universal MAC time” or “network time.” Also, in at least one embodiment, the mactime.offset value will be present to adjust the local node's MAC timer value in order to arrive at the virtual “universal MAC time.” Other variables such as the absolute frame count and the talk slot count are updated using the new MAC time from the remote sender, and the MAC commands the PHY to stop the continuous receive operation and transition to the SYNCED state.

Referring again to FIG. 15, the MAV networking system SYNCED state 1504 can represent a key subnet operational mode for maintaining synchronization. In one or more embodiments, the SYNCED state 1504 occurs when a MAV subnet is idle with no audio transmissions in progress, and the purpose of such an interval is to provide every node on the subnet with its own dedicated frame time to transmit its sync packet that carries its 64-bit MAC time. Before a transmission can occur, a node is required to perform an energy scan to ensure that their assigned talk slot is not in use by another radio system, and because, in an example embodiment, there are a maximum of 32 nodes that can be supported on a subnet, the total time required for one sync interval is [(32 Sync Transmit Frames)+(32 Energy Scan Frames that precede every Sync Transmit Frame)]×(10 milliseconds per frame)=640 milliseconds. Each node's unique device ID is used to determine which sync transmit frame is allowed to transmit its sync packet. For example, device ID 0 can be assigned to the first sync transmit frame, device ID 1 can be assigned the second sync transmit frame, and so on. In such an example embodiment, the sync provider transmitting its sync packet during the sync interval always does so in the fourth talk slot of the frame.

The sync interval, in such an embodiment, is always 640 ms in duration regardless of the number of nodes connected to the subnet. Because all nodes have been synchronized to the same “Universal MAC Time,” the nodes can all maintain an identical frame count across the subnet. Nodes that are not supposed to transmit their sync packet will be in the SYNCED state 1504 ready to receive the sync provider's sync packet. The single node assigned to be the sync provider in a given frame will transition to the SEMI-ACTIVE state 1506 to conduct their transmit operation. This SEMI-ACTIVE state 1506 is dedicated for sync packet transmissions during the sync interval.

Another aspect of the sync interval and the sync process, in one or more embodiments, is that a local node determines which remote node's sync packet to use by always using the sync packet from the lowest device ID from which it receives sync information. This can be seen, for example, as part of step 1602 in FIG. 16, by testing to ensure that the sender of the sync packet has a lower device ID in order to proceed with the sync process.

Another aspect of the subnet sync process is that every time a node transmits voice packets as a direct talker, or repeats voice packets as a repeater in a mesh topology, the node also sends its latest MAC time in the sync packet portion of the common data packet. Accordingly, receiving nodes will still continue the sync process during times of active voice transmissions.

Referring again to FIG. 15, the SYNCED state 1504 is the primary state for RECEIVE operations, and these operations can include sync packet receptions during the sync interval, voice packet receptions during periods of active transmission, and repeated voice packet receptions transmitted by dedicated repeater nodes when a subnet is operating in the mesh topology mode.

When a node, in at least one embodiment, is in the SYNCED state 1504, the node no longer conducts an asynchronous extended continuous PHY receive operation. Instead, while in the SYNCED state 1504, the MAC commands the PHY to commence a receive operation that is synchronized to the node's SOF boundary and which lasts for 22 of the 24 PHY slots in the frame. Recall that conditions causing the MAC sync state FSM to transition from a RESET state 1502 to a SYNCED state 1504 can include reception of a packet or completion of a timeout period (e.g., after an approximately one minute timeout period). The latter case forces the node to transition to the SYNCED state 1504 even though the subject node may not have determined the existence of another node or nodes on the subnet. This state transition will force the node to eventually transmit its sync packet during its assigned sync transmit frame in the SEMI-ACTIVE state 1506 and then return to the SYNCED state 1504. Accordingly, in such an embodiment, each node is forced to perform a transmit operation during initial network formation so that the nodes are discovered while nodes are trying to find each other in the RESET state 1502.

Also, in one or more example embodiments, valid state transitions out of the SYNCED state 1504 can include transitioning to the SENSE state 1508 to perform an energy scan prior to a transmission, and returning to the RESET state 1502 due to an error condition and/or periodically after a long operational time.

During a sync interval, at every SOF boundary, the MAC checks to see if it is time for the subject node to transmit the node's sync packet by comparing the current frame count modulo 32 with the node's device ID (note that, in such an embodiment, the frame count includes both the energy scan frame and the sync transmit frame into a single count such that there are exactly 32 sync frames for purposes of this comparison). If the comparison is false, then the node remains in the SYNCED state 1504 for the MAC to schedule another PHY receive operation to listen for a sync packet from the next node within the sync interval process during the next sync frame. Alternatively, if the comparison is true, then the node transitions to the SENSE state 1508 to perform a one frame energy scan before the node schedules its sync packet transmission during the SEMI-ACTIVE state 1506.

While in the SYNCED state 1504, if the node has voice data to transmit (e.g., as a direct talker or as a repeater), the node again transitions to the SENSE state 1508 to perform the one frame energy scan before the node schedules a voice packet transmission during the FULL-ACTIVE state 1510.

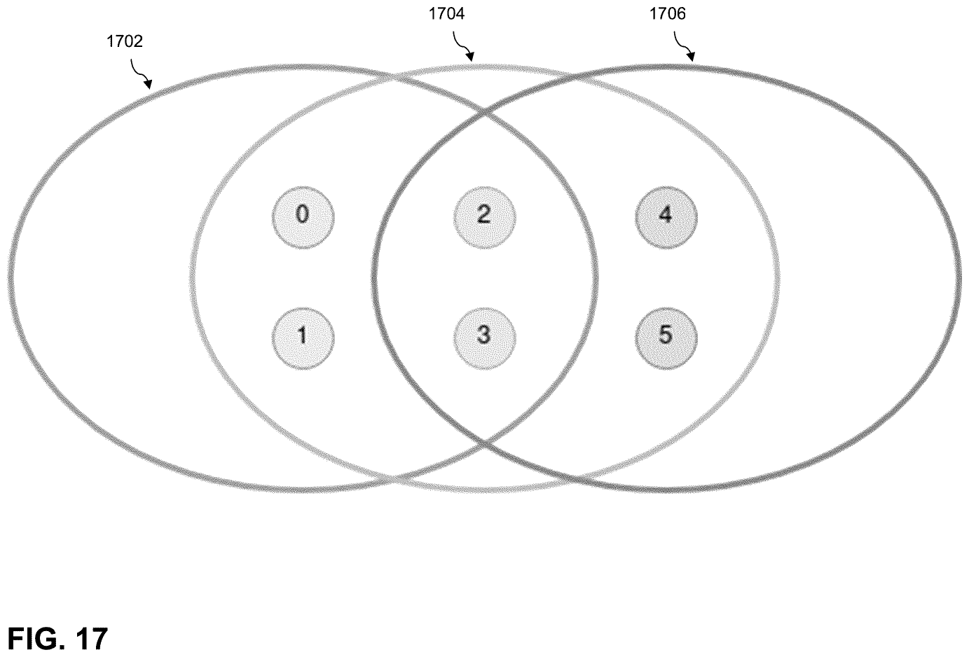

As noted above, the SENSE state 1508 is used to perform an energy scan in the frame prior to the frame that a node will transmit in. Given that an energy scan reveals a clear talk slot to communicate in during an energy scan frame, the MAC determines that it can transmit in the next frame and enters either the SEMI-ACTIVE state 1506 to transmit its sync packet during the sync interval, or enters the FULL-ACTIVE state 1510 to commence a voice packet transmission in the available talk slot in the subsequent data transmission frame by scheduling the transmission with the PHY in that slot. Within this frame, the MAC can also schedule receive operations with the PHY in the remaining talk slots in the frame to ensure that the node can listen to transmissions from other nodes in the same frame. FIG. 17, as further detailed below, illustrates a node with audio data to transmit. Once a voice data transmission has commenced in a given frame, the node continues to transmit in the same talk slot in subsequent contiguous frames without performing another energy scan until the entire audio message has been transmitted.

Referring again to FIG. 15, a node transmits its sync packet within the SEMI-ACTIVE state 1506 during the frame that the node is assigned to transmit in based on its device ID. Additionally, a node performs direct voice packet transmissions within the FULL-ACTIVE state 1510 in the talk slot that the node has been assigned. Additionally, a node also performs dedicated repeater voice packet transmissions during Talk Slot 4 within the FULL-ACTIVE state 1510, as well when operating in the mesh topology mode, as further discussed herein.

Also, one or more embodiments include performing synchronization techniques during the SYNCED state 1504, the SEMI-ACTIVE state 1506, and the FULL-ACTIVE state 1510. In addition to SOF timing corrections (e.g., such as during the RESET state 1502), in the SYNCED state 1504, the SEMI-ACTIVE state 1506, and the FULL-ACTIVE state 1510, MAC sync errors are accumulated. For a number of accumulated sync errors (e.g., less than or equal to 1600), a timing correction is determined using at least one correction factor applied to the number of sync errors that results in an adjustment to the next SOF time. This adjustment is applied to the MAC timer SOF interrupt compare register to modify the SOF timing. For example, when the current node is actively transmitting, the correction factor is 10% of the sync error count, and when the node is not actively transmitting, the correction factor is 30%. Also, when the sync error count exceeds a given error threshold (e.g., a threshold of 4000 errors), the MAC determines that the error count is excessive and that the node must be placed back in the RESET state 1502 to resync itself to the subnet from a network entry perspective.

As also detailed herein, one or more embodiments can include supporting multiple MAV network topologies. More particularly, in such an embodiment, the MAV network system can support distinct infrastructure-free topologies including, for example, a peer-to-peer direct topology and a mesh topology. Configuration of the desired topology must be made before attempting to form a subnet with two or more nodes, and all nodes that are intended to operate on the subnet must be configured with the same topology.

In at least one embodiment, a peer-to-peer direct topology can include an ad hoc topology wherein every node in the subnet communicates directly with every other node in the subnet that is within range. If a particular node leaves the range of another node, the two nodes cannot communicate. This topology can, in one or more embodiments, have the lowest end-to-end latency for voice and data traffic.

Additionally, in at least one embodiment, a mesh topology can include an ad hoc topology that supports repeater nodes in between source and destination nodes. As detailed herein, repeater nodes in a MAV network system can serve one or more benefits over a direct topology. For example, repeater nodes can enable a source node to transmit at a lower transmit power level to a destination node by communicating to and through a repeater node in order to achieve the same range as that obtained between a source and destination node in the direct topology. This can result, for instance, in battery power usage savings as well as lowering the transmitting node's RF signature for low probability of intercept (LPI) and low probability of detection (LPD) purposes, which can be important for various applications (e.g., military and defense applications).

Additionally, repeater nodes can enhance the coverage of a subnet in communication-impaired locations. For example, a repeater rode could be placed at the entrance to an underground mine, subway, etc. in order to enable communications between subterranean nodes and above-ground nodes. Similarly, repeater nodes could be placed at the intersection of an urban canyon for the purposes of extending communications between city blocks (e.g., by extending coverage around corners of tall buildings) in an urban canyon environment.

Further, repeater nodes in a mesh topology can extend the end-to-end range between two endpoint nodes. For example, a repeater node can effectively double the range in a case wherein three nodes are lined up in a “string of pearls” arrangement with the repeater node in the center. By way merely of example, in any given frame wherein one to three nodes are actively transmitting voice packets, a dedicated repeater slot in Talk Slot 4 is available for an elected repeater node to repeat the packets of all three of these talkers in the next available frame time, which is typically two frames later.

Also, and as further detailed herein, one or more embodiments include facilitating all connected nodes monitoring each other's transmissions to form and maintain their connection graph, indicating the closest and most optimal nodes to repeat their transmissions. In such an embodiment, every time a node transmits information of any type (e.g., sync, voice, repeated voice, etc.), the node includes its latest connection graph and vote for its selected repeater node. Other nodes use the connection graph to keep their own graph fresh and/or current, and each node monitors the repeater vote from the maximum of three talkers that can transmit in a single frame to determine if they are the elected repeater in the next frame.

As noted above, in one or more embodiments, all transmitting nodes share their connection graph every time they transmit. The contents of connection graphs and repeater-related fields in the OTA common data packet are further described herein. Included within this information is not only the node's current connection graph, but also the node's vote for the node it believes will be its optimal repeater based at least in part on a set of rules to apply the connection graph node mappings. In an example embodiment, because there is only a maximum of three direct transmitting nodes in any given frame, there are only three repeater votes per frame that need to be comprehended by all connected nodes in range of the talkers. A device with the most votes in a frame will be elected as the repeater in the next frame. All nodes must monitor the repeater votes to determine if they have been elected by the talkers as the repeater. Theoretically, a new repeater could be elected in each frame.

Additionally, in one or more embodiments, a connection graph is a 32-bit data structure wherein each bit in the data structure represents a node's connection to another node, and the bit positions correspond to a node's device ID. In other words, bit 0 in a connection graph is related to the node with device ID=0, bit 1 is related to the node with device ID=1, and so on. A bit value of 1 at specific bit position (i) in the connection graph indicates that the local node has received a packet from the indicated remote node (i) recently, wherein recently is a maximum of three sync intervals (3×640 msec). A bit value of 0 indicates that the local node has not received a packet from the remote node (i) recently.

FIG. 17 shows example mesh topology in an example embodiment. By way of example, FIG. 17 depicts a simple example of a mesh topology to illustrate how the connection graphs can be formed. More particularly, FIG. 17 shows six nodes with device IDs 0 through 5, and the nodes are shown positioned at the center of ovals 1702, 1704 and 1706, which indicates the nodes' range and/or coverage area. More specifically, nodes 0 and 1 have the coverage indicated by oval 1702, nodes 4 and 5 have the coverage indicated by oval 1706, and nodes 2 and 3 have the coverage indicated by oval 1704. FIG. 17 illustrates the connection graphs developed by each of the six nodes in the mesh topology example, and is further detailed below in connection with Table 9. Note also that, in one or more embodiments, the connection graph entries always use a 0 for their own device ID, and a value of 1 in a remote node's bit position of a local node's connection graph indicates that the remote node is within the coverage area of the local node.

TABLE 9

| Device ID | Connection Graph |
|---|---|
| 0 | 00000000000000000000000000001110 |
| 1 | 00000000000000000000000000001101 |
| 2 | 00000000000000000000000000111011 |
| 3 | 00000000000000000000000000110111 |
| 4 | 00000000000000000000000000101100 |
| 5 | 00000000000000000000000000011100 |

As previously noted, in at least one embodiment, these connection graphs are shared in every transmitted packet, and the graphs are cached by each receiving node.

Additionally, when a device transmits audio data, the device will also vote for the repeater node that it wants to repeat its audio data. In one or more embodiments, the node uses its cached connection graph, which it has created and maintained from receiving the graphs from other nodes, to determine its repeater vote. Also, one or more rules can be used for determining the repeater vote. For example, such a rule can include that the repeater candidate must hear and be heard by the transmitting node (i.e., the voter). This implies that the transmitter must have actually received a connection graph from the candidate recently (i.e., the transmitter can hear the candidate), and that the candidate's connection graph actually shows that the transmitter is also a connection of theirs (i.e., that the candidate can hear the transmitter). Additionally, such a rule can include that the repeater candidate must not be transmitting themselves. Of the remaining devices that are left after such rules are applied, the candidate that wins the vote for a given transmitter is the candidate that has the most connections to devices that the transmitting device does not already have.

Note also that if no suitable candidate is found, then, in at least one embodiment, the transmitter will send a null vote that will not be counted in the election. In the case of multiple equally suitable candidates, the transmitter will choose the device with the higher device ID.

Also, in one or more embodiments, elections for a repeater happen once every frame. Votes from all transmitted audio packets are tallied, and the repeater can be chosen according to the following rules: The repeater will be the device with the most votes in an election, and if there is a tie, then the device with the highest ID will be chosen, and if there are no votes or all votes are null, then no repeater will be chosen.

Additionally, at least one embodiment includes implementing PHY adaptation. As is to be appreciated by one skilled in the art, the PHY of any communication network is the lowest architectural layer of the corresponding system. During an information transmit operation by a particular radio, the PHY is responsible for receiving data from the upper layers, encoding the data for transmission robustness, digitally modulating the encoded information bitstream to create information symbols using a particular modulation scheme such as QPSK or quadrature amplitude modulation (QAM), performing digital-to-analog conversion of the signal, further modulating an RF carrier signal with the resulting analog baseband signal and physically transmitting the waveform over the communication network wireless medium. For a data receive operation, the PHY performs the opposite operations by tuning to the RF center frequency of the carrier waveform, down-converting the RF waveform to remove the RF carrier, performing analog-to-digital conversion to extract a digital baseband signal, demodulating the symbol streams to obtain digital bit streams and decoding these bitstreams before passing the originally transmitted data information to the upper layers.

Because conventional wireless communications standards (e.g., 3GPP's multiple generations of cellular radio standards) typically specify all of the communication layers together in a coupled fashion with timing requirements between layers, the PHYs are not typically intended to be readily adaptable to other heterogeneous wireless networking stacks. In contrast, in one or more embodiments, the MAV stack architecture defines an abstracted set of universal functionality and interchange requirements that can be applied by the DLL to different PHYs for configuration and control of their corresponding radio implementations. The function that implements this abstraction layer within the MAV stack is referred to herein as the PHY-to-DLL universal interface (P2DLL-UI), is as further detailed herein. The flexibility that the P2DLL-UI offers enables a product developer, for example, to choose the PHY option with the optimal characteristics for a specific use case (e.g., optimal PHY for long/short range, RF frequency band of operation, high/medium/low voice quality, etc.). One P2DLL-UI implementation which represents an example embodiment of an adaptation between a specific PHY and the PHY-agnostic common layers of the MAV stack above can include an adaptation to the DECT-2020 PHY. Other PHY adaptation examples can include the classic DECT PHY specified in ETSI EN 300 175-2, and at least one LoRa PHY. In each such case, a unique P2DLL-UI is developed to provide the interface between a vendor-supplied PHY API and the common DLL which the rest of the MAV stack resides above. It should also be appreciated by those skilled in the art that the PHY-specific adaptation functions that comprise a particular P2DLL-UI can be implemented in a single entity such as a single source code file, or can be distributed across two or more functional blocks and/or source code files.

Regardless of the specific PHY option selected, the P2DLL-UI provides a thin hardware abstraction layer to interface the MAV stack to a third party PHY SoC, SiP, and/or wireless module containing an SoC or SiP via a semiconductor manufacturer-supplied API. Such vendor-supplied PHY APIs can be specific to the underlying modem implementation and typically use vendor-unique, non-standard information formats for interfacing to upper layers above the PHY. To support multiple PHY options, however, it can be advantageous to use a common information format to abstract the uniqueness of each different PHY and its API such that all layers above the P2DLL-UI can leverage a single common data structure for communications. Therefore, a primary operation of the P2DLL-UI is to map this common data structure presented by the upper layers above the P2DLL-UI into the vendor-specific structure for a particular PHY API option.

One or more embodiments also include leveraging RF spectrum utilization. In order to adapt a common networking stack to a variety of heterogenous radio implementations at the PHY, the P2DLL-UI must be RF spectrum frequency-agnostic and have a parameterizable means of describing the key characteristics of the PHY in a common way. To accomplish this need, the P2DLL-UI implements an abstracted set of universal functionality and interchange capabilities that are applied by the DLL to the different radio implementations. It is to be appreciated, however, that one or more embodiments are not restricted to this particular illustrative manner of abstraction, and that other ways of describing the same PHY parameters in a general way for the purposes of configuring a specific PHY are comprehended by one or more embodiments as well.

An example embodiment in which the MAV stack defines PHY channels and spectrum utilization via binary encoding of the channel space are detailed below with proper configuration of the following parameters for a specific PHY: localization (parameterized), regulatory environment (parameterized), size of subchannel (fixed: value depends on radio implementation), and the number of subchannels per channel (parameterized).

Configuration of localization and regulatory parameters, which describe the RF spectrum that the MAV stack together with a specific PHY are intended to operate within for a specific product, can be defined within an 8-bit field referred to herein as the localization and regulatory ID (LRID). In an example embodiment, bit 7 is the EXT bit, provides for custom extensions of the encoding, and can typically be set to zero. If set to 1, the lower 7 bits do not conform to this specification and instead rely on a proprietary implementation. Bits 6:3 represent the localization ID which describes the regional information relevant to define the spectrum. Also, regulation ID describes the regulatory specification(s) applied within the localized regulatory environment, and the regulation ID is not orthogonal and depends on the localization ID.

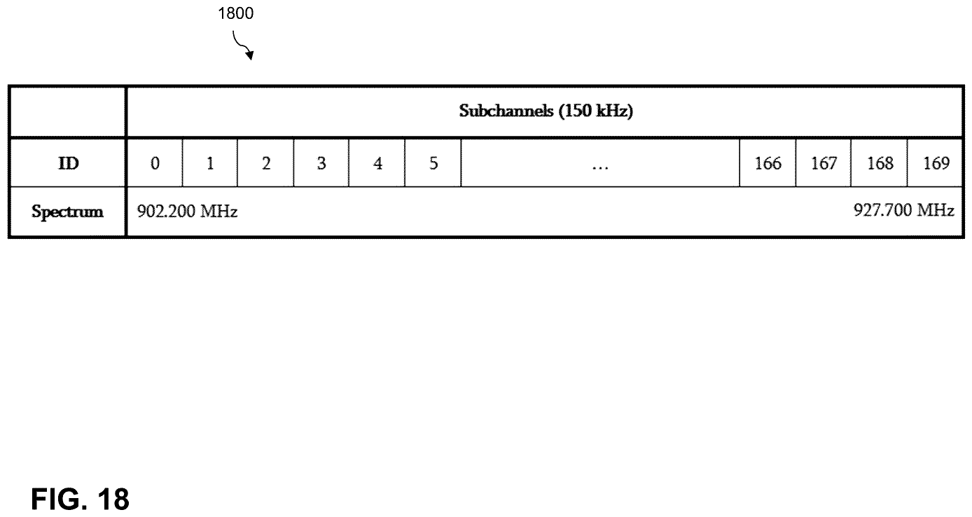

For a spectrum defined by the LRID as described above, the manner in which the spectrum is divided into a finite set of subchannels is further specified within a 10-bit field referred to herein as the subchannel ID (SCID). The bandwidth of a particular subchannel can be defined by the PHY radio specification which is referenced in the LRID. For example, the example ITU region-2 915 MHz ISM band can be divided into 170 subchannels with a spacing of 150 kHz. For this example, SCID field encoding is shown in FIG. 18.

FIG. 18 shows SCID field encoding 1800 with respect to ITU region-2 in an example embodiment. By way of example, as depicted in FIG. 18, each subchannel can be referenced explicitly by its SCID, which is derived from its position within the spectrum. Subchannel IDs, in such an example, are assigned within the SCID field from lowest-to-highest absolute frequency values beginning at SCID(0).

In at least one embodiment, for radio implementations with a single, uniform physical channel width, the center frequency of the modulated signal is always the center of the subchannel. For radio implementations capable of variable physical channel width, multiple, contiguous subchannels may be banded into a physical channel. In this case, the channel can be described by the ID of its lowest frequency subchannel and the number of subchannels it bands. The center frequency of the physical channel is the center frequency of the pack of subchannels.

Also, the spectrum, regulatory regime and channelization parameters in a common manner are detailed herein, in accordance with one or more embodiments, as part of the common data structure used by the MAV stack to configure a PHY operation. However, one or more additional parameters can be required to fully specify the physical channel, including the bandwidth to be used by the radio to transmit or receive modulated information, in order to properly configure the specific PHY operation. To complete this specification, the MAV stack uses a data structure referred to herein as a PCD, which specifies all parameters needed to configure the PHY such that all nodes executing the MAV stack can interoperate over the network given the same radio.

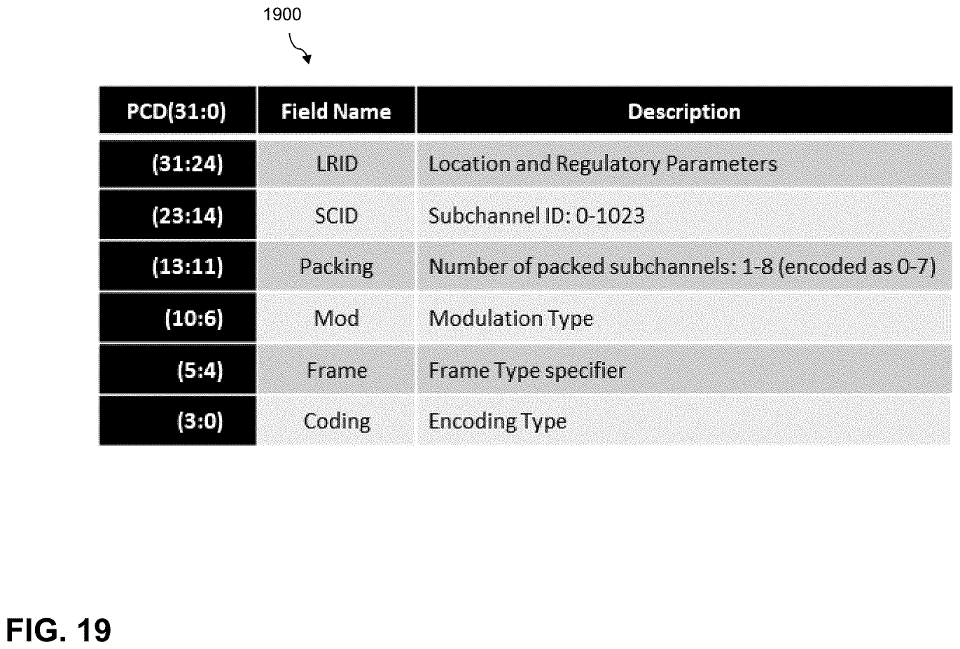

FIG. 19 shows at least one PCD in an example embodiment. By way of example, FIG. 19 depicts an example PCD 1900 which is 32 bits in length and combines information include localization and regulatory parameters, subchannel specifiers, the number of banded and/or packed subchannels, modulation parameters, frame type specifiers, and encoding parameters.

For transmit operations, in one or more embodiments, the MAC layer passes the data to be transmitted along with a PCD and other information to the P2DLL-UI, which then extracts information from the common PCD structure and maps it into the relevant fields of a PHY transmit operation command. Conversely, in a receive operation, the PHY passes PHY specific information including the received data to the P2DLL-UI, which in turn extracts the control information from the PHY-specific data structure and maps it into the relevant fields of the PCD to pass on to the DLL and the layers above the DLL. PHY operations can include other types besides transmit and receive, but a fundamental model is the same making use of the common PCD format which is mapped to/from the PHY API function calls.

Also, additional fields that are not described above but can be included in the PCD can include PCD(10:6), PCD(5:4), and PCD(3:0). More particularly, PCD(10:6) is an encoded field to represent all possible modulation and coding scheme (MCS) options that the PHY supports. For a single PHY transaction operation, this field controls the PHY to use a particular MCS scheme. For a single receive operation, this field contains the MCS scheme that was used by the transmitter of the received packet. PCD(5:4) is a frame type specifier that is used to indicate different packet header options that a particular PHY supports. As with MCS, the field signifies to the PHY which header type is being used in conjunction with the data to be transmitted for transaction operations. For receive operations, this field indicates which header and/or frame type was transmitted so that the header and/or frame can be interpreted correctly. Further, PCD(3:0) is a field that is used in the PCD to indicate the encoding method used for data to be transmitted and, for received packets, the type of encoding used on the received data such that it can be properly decoded.

In at least one embodiment, the MAV networking system architecture is developed and/or implemented with a holistic approach to network security, including flexibility for end-user device original equipment manufacturers (OEMs) to configure their products with different levels of security to suit the application. Aspects of the system's end-to-end security architecture include, for example, secure device commissioning (including, e.g., the MAV networking system's process to grant and revoke authorizations), platform security (including, e.g., the protection of cryptographic secrets against unauthorized use or corruption), data authentication (including, e.g., detection and/or rejection of data from unauthorized devices by authorized devices on the network), secure authenticated access (including, e.g., requiring MAV network devices/nodes to satisfy a cryptographic mutual authentication key exchange in order to gain secure subnet access), and secure data transmission (including, e.g., use of 256-bit (e.g., AES-256) data encryption to maintain data secrecy and ensure that secure data is only shared with authorized devices).

By way of illustration, consider the following admission security levels associated with one or more embodiments. For example, Admission Level-1, also referred to as the MAV open network level of admission security operates in similar manner as an open Wi-Fi network wherein any client device (e.g., a laptop or smartphone) can join without entering a passcode or entering information via a Wi-Fi captive portal. When an end-user engages an MAV networking system-enabled product for the first time using the default network ID, it is considered to be capable of operating on the default open MAV network with any other device that is using the default network ID on the same RF channel. In this case, there is no network configuration necessary other than giving the unit a unique device ID.

By way of further example, Admission Level-2, also referred to as the lightly secure network admission level, involves configuring every node that is intended to be operated together on the same subnet with the same network ID. Note that in addition to the network ID, the nodes must all be configured to operate on the same RF channel as well. Assuming that the PHY option being used supports five different RF channels (as is the case, e.g., with the example DECT-2020 PHY in the US), this implies that an in-range, unauthorized node must be configured for one of 1,280 possible subnet configurations (e.g., when the system is configured to use only 8-bits of network ID) to gain unauthorized access. To greatly diminish the probability of unauthorized access, a full 32-bit network ID for the DECT 2020 case can be used.

Also, for example, Admission Level-3, also referred to as the enhanced secure network admission level, includes employing a highly secure network formation and JOIN process option based at least in part on the Diffie-Hellman key exchange method and mutual authentication of every JOINing device on a secure subnet. There can be two device operational situations wherein a node can JOIN a subnet, each with communications over a different medium: OTW during device commissioning, and OTA after the device has been commissioned.

In at least one embodiment, a secure subnet initial formation and ongoing JOIN process involves two tasks that need to be accomplished: device authentication, and key sharing. Also, in such an embodiment, the pre-requisite steps for network formation and the process of formation and ongoing JOIN for node subnet admission are further described herein. For example, such steps can include node/device commissioning for a designated network, and secure subnet creation. Further, secure subnet formation and continued admission can include secure subnet discovery, mutual authentication, secure channel establishment, and subnet access. Additionally, device authentication can include, during JOIN, exchanging, via devices, a number of parameters in order to verify if the devices belong to the same designated network and/or if the devices are authenticated for the specific subnet.

At least a portion of such parameters can be independently chosen during the JOIN process, and the combination of authenticated parameters can be referred to herein as the authentication mode. In the enhanced secure network admission level, the role of a JOIN arbitrator can be negotiated in the early stages of network formation to facilitate a secure mutual authentication process. In one or more embodiments, the arbitrator is responsible for dictating the authentication mode during JOIN, and may be specified when the network settings are loaded (e.g., commissioning). The authentication component of JOIN can be skipped, for example, if no parameters are selected by the JOIN arbitrator. In addition, the arbitrator can request authentication methods on a per-device level, if desired.

The authentication process can also utilize a challenge-response flow, which takes place between a verifier, the device issuing the challenge, which will verify the correctness of the completed challenge, and a prover, the device responding to the challenge. If the procedure is completed successfully, the prover's identity is deemed authenticated.

More particularly, a challenge (e.g., a random bye payload) can be sent from the verifier to the prover, and the prover can perform at least one cryptographic operation on the payload that only the prover can perform. The authentication mode will dictate the exact composition of the challenge operation. For instance, a security code shared offline might be hashed with the random payload as part of the challenge. The prover then sends the challenge back to the verifier, along with any public knowledge required for verification. Such public information can include, for example, the device's public join key, the device's certificate (e.g., if verifying the device's network membership), and/or other information. The verifier may then verify the correctness of the challenge, and if the verifier's solution is the same as the response from the prover, then the prover has been identified.

By way of illustration, in one or more example embodiments, the JOIN process can include using the following algorithms and elements. For instance, a challenge payload can comprise 16 bytes, generated by a pseudo-random number generator (PRNG)). With respect to the prover, if network authentication is requested, ECC_Encryption P-256 can be used with the JOIN private key, along with SHA_256 of the received challenge payload, and the prover's Diffie Hellman public key. If subnet authentication is requested, at least one passcode can be used. With respect to the verifier, if network authentication is requested, ECC_Decryption P-256 can be used with the with prover's public key, along with SHA_256 of the sent challenge payload, and the prover's Diffie Hellman public key. If subnet authentication is requested, at least one passcode can be used. Additionally or alternatively, if network authentication is requested, ECC_Decryption of a signature with commissioner's public key can be used, alone with SHA_256 hash of the certificate. If both quantities are equal, then the certificate is valid. If both quantities match and the certificate is valid, then authentication is successful.

Also, in one or more embodiments, during JOIN, the devices will share the keys required for a secure MAC channel. When sharing keys, one of two modes is possible: devices sharing MAC keys or devices sharing a cryptographic schema. With respect to devices sharing MAC keys, the keys will be wrapped with a shared secret derived from a Diffie-Hellman process. The Diffie-Hellman process can be overlayed with the authentication detailed above, so as to prevent man-in-the-middle (MITM) attacks during the key exchange process from unauthenticated devices. With respect to devices sharing a cryptographic schema, such a schema can point to keys that are pre-loaded during a commissioning phase. This mode can be chosen even if devices do not have pre-shared keys, but the MAC layer channel will be unsecured. Because the mode will include key IDs (not the keys themselves), this information may be transmitted in the clear. Further, no ephemeral key is required for this process.

In at least one embodiment, the key sharing process can be determined by the key sharing mode (e.g., as specified by the arbitrator). Also, in the key sharing process, various algorithms can be used with respect to tasks of shared secret derivation (e.g., an Elliptic Curve Diffie-Hellman (ECDH) P-256 curve), shared secret implementation (e.g., public key*private key), and ephemeral key derivation (e.g., SHA_256 (shared secret)).

Also, in one or more embodiments, the commissioning of an end-user device that is equipped with the capability to communicate over a MAV networking system refers to configuring the device with enterprise-specific information, protected security keys, and one or more certificates owned by the enterprise for secure operation over the enterprise network. Commissioning of an end-user device can take place, for example, at one of several different points in the supply chain including, at the OEM's end-user product manufacturing facility, at the OEM's distributor warehousing facility, and/or somewhere within the end-user's organization (e.g., military supply and/or logistics depot, aviation squadron radio equipment shop, fire department comms gear specialist, etc.).

During commissioning, the device can be configured with at least the following information: commissioning certificate; subnet network ID and device ID credentials, a device-unique public key; commissioner's public signing key; validity period for the certificate; and a device-unique private key.

In addition, the certificate above can be signed by the commissioning entity before the certificate is written to the device. Further, in one or more embodiments, once the device is commissioned, the device is considered part of the given enterprise network.

In at least one embodiment, when a group of commissioned end-user devices power-up to attempt to form a new subnet, the subnet does not exist and must be created by one or more of the devices themselves. Subnet creation is a process by which a minimum set of subnet parameters are generated for the new subnet, and because all nodes within the end-user devices are running a replica of the MAV stack software and are all commissioned in the same fashion, the devices all have the capability to create the subnet. However, in one or more embodiments, only one device is permitted to actually create the subnet. Accordingly, when a device powers-up, the device enters a continuous receive mode for a predetermined time period to search for other devices that may have already created the subnet. If the time period elapses without finding an existing subnet, the device goes through the subnet creation process and begins advertising the subnet OTA and/or OTW. The device that ends up creating the subnet can then serve as an arbitrator for the network formation process as other nodes JOIN and begin the mutual authentication process. Alternatively, if the search time elapses without finding an existing subnet, the MAV stack can enter a wait period for instructions from the application to create a new subnet rather than automatically creating a new subnet.

In at least one embodiment, at least the following parameters are generated and/or configured to create a new subnet: MAC encryption keys and nonce; MAC/PHY seeds and/or parameters; maximum device count; short↔long address mapping for itself (e.g., a process wherein each device has a longer unique identifier that gets mapped to a shorter “virtual ID” (VID) during subnet formation and has one of a designated total values to uniquely identify each one of possible devices on a given network); minimum security schema for the subnet (which, e.g., dictates minimum authentication requirements); and/or subnet JOIN schema (e.g., restrictions on admission of new nodes, restrictions on OTA or OTW JOIN, etc.).

Once a subnet has been created and subnet formation arbitration commences, other devices can begin participating in the formation process. In at least one embodiment, the arbitrator takes responsibility for transitioning devices through network admission phases, which allows the arbitrator to manage the process across multiple joiners if necessary.

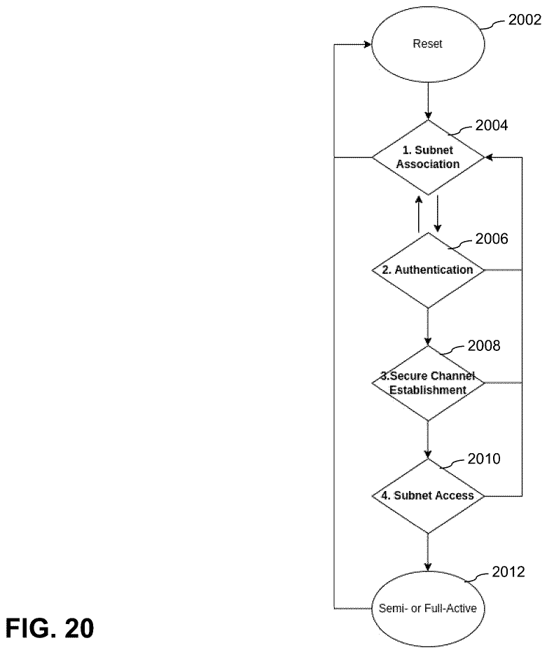

FIG. 20 shows a workflow related to secure subnet admission phases in an example embodiment. As depicted in FIG. 20, and as described in further detail below, step 2002 includes implementing a reset phase, step 2004 includes implementing a subnet association phase, and step 2006 includes implementing an authentication phase. Additionally, step 2008 includes implementing a secure channel establishment phase, step 2010 includes implementing a subnet access phase, and step 2012 includes implementing a semi-active or full-active phase.

In addition to further describing the phases in FIG. 20 in more detail below, the responsibilities of the JOINER and ARBITRATOR roles are also outlined. For all messages, one or more embodiments can include employing a retry mechanism if the integrity of the message fails. In this case, the contents of the message will not be interpreted.

The secure subnet association phase, such as depicted in step 2004 in FIG. 20, is intended to identify the existence of one or more active subnets on the medium, to determine the arbitrator(s) of the one or more active subnets, and to evaluate the initial join fitness. Such an evaluation can include determining whether the join request contains any information that excludes the device from joining the subnet. Also, the secure subnet association phase can include transitioning to a joining medium (for example, wherein the JOIN process begins OTA and then is required by the device application to transition to OTW for enhanced security).

Table 10 below describes the steps for the JOINER role process flow associated with a secure subnet association phase.

TABLE 10

| Step | Description |
|---|---|
| 1.j.a. | The JOINER accesses the medium and begins to search for active subnets. |
| 1.j.b. | The JOINER continues to search to find a subnet. |
| 1.j.c. | The process is repeated until a timeout is reached or until the process is canceled by the |
| | application. |
| 1.j.d. | After identifying a potential subnet, the JOINER device identifies the appropriate time |
| | to issue a join request. This determination will vary by medium. This step may also |
| | involve any required operations for medium access (e.g., time sync). |
| 1.j.e. | The JOINER sends a join request to the ARBITRATOR. The join request contains |
| | information required to assess the initial fitness of the JOIN operation, such as the |
| | device's long address, the device's short address, the device's eligible MAC modes |
| | (and mode preference), the security schema supported, and, optionally, security-related |
| | JOIN data from the application. |
| 1.j.f. | After sending the request, the JOINER device waits for notice to proceed from the |
| | ARBITRATOR. The notice to proceed may contain information for accessing a |
| | different medium to continue the joining process (for example, transitioning to a |
| | different MAC mode such as a bursty MAC). This message may also contain an |
| | indication of failure. In this case, the JOINER may transition back to a subnet search, |
| | or terminate the join process altogether. |
| 1.j.g | If the JOINER received instructions to access an alternative MAC, the JOINER |
| (opt) | immediately transitions using the given parameters. The remainder of the joining |
| | process will continue there. |
| 1.j.h | Once the JOINER has transitioned to the alternative MAC (if specified), the JOINER |
| (opt) | will delay for a predetermined time and send a message to the ARBITRATOR to |
| | indicate that it (i.e., the JOINER) has transitioned. |
| 1.j.i. | The response from the ARBITRATOR to the JOINER will contain one of two |
| (opt) | messages: an instruction to proceed with the join, or a request to wait for further |
| | instruction. This allows the ARBITRATOR to potentially coordinate multiple devices |
| | at once, bringing them all to the alternative MAC first. |

Note that if there is no existing subnet, a joining device will not proceed past step 1.j.c. At that point, the JOINER has not discovered a subnet in range. As stated previously, the MAV stack can be configured for the JOINER to automatically create the subnet, or to wait for instruction from the application to create the subnet. In either case, the JOINER then becomes the arbitrator for other devices that eventually attempt to JOIN.

Table 11 below describes the steps for the ARBITRATOR role process flow associated with a secure subnet association phase.

TABLE 11

| Step | Description |
|---|---|
| 1.a.a. | The ARBITRATOR in an existing subnet receives a join request from a JOINER |
| | device. |
| 1.a.b. | At the first JOIN request of any device, the ARBITRATOR validates and assumes its |
| | role. The ARBITRATOR then facilitates the rest of the joining process. |
| 1.a.c. | The ARBITRATOR assesses the JOINER device's join request for fitness. This may |
| | involve, for example, comparing the JOINER's identity credentials with a deny or allow |
| | list, and/or evaluating any application information in the join payload. |
| 1.a.d. | If the JOINER is not fit to join the subnet, the ARBITRATOR sends a notice of failure. |
| 1.a.e. | If the JOINER is fit to join, the ARBITRATOR sends a notice to proceed. This payload |
| | will have the security schema which specifies the authentication and secure channel |
| | establishment format, and may contain information for the JOINER to continue on a |
| | different medium. If this is the case, any parameters necessary for medium access need |
| | to be included. |
| 1.a.f. | At this point, the ARBITRATOR should transition to the new medium (if required). |
| 1.a.g. | The ARBITRATOR waits for the readiness indication from the JOINER. If the |
| | ARBITRATOR fails to receive an indication after a timeout, the ARBITRATOR may |
| | return to normal operation. |
| 1.a.h. | Once a readiness indication has been received, the ARBITRATOR must determine if it |
| | (i.e., the ARBITRATOR) should usher more joining nodes through subnet association |
| | first, or follow the join to completion with the initial/current device. If the |
| | ARBITRATOR will follow the process through with this JOINING device, it (i.e., the |
| | ARBITRATOR) may proceed directly to the next phase. |
| 1.a.i. | If the ARBITRATOR wishes to find more joining devices first, it (i.e., the |
| | ARBITRATOR) may send a message instructing the JOINER to wait for further |
| | instruction. The ARBITRATOR may then resume the process at a future time once it |
| | (i.e., the ARBITRATOR) is prepared to do so. The payload should include a specified |
| | time at which the ARBITRATOR is expected to resume, such that the JOINER may |
| | time out appropriately if the ARBITRATOR fails to return. |

As noted above and further detailed herein, one or more embodiments include implementing a secure subnet mutual authentication phase. Such an authentication phase is intended to accomplish mutual authentication of both JOINER and ARBITRATOR, as well as to derive a shared secret (e.g., for use during secure channel establishment).

Table 12 below describes the steps for the JOINER role process flow for secure subnet mutual authentication.

TABLE 12

| Step | Description |
|---|---|
| 2.j.a. | The device waits for an authentication request from the ARBITRATOR. The process |
| | may fail if the JOINER does not receive an authentication request before a timeout. |
| 2.j.b. | Once the authentication challenge is received from the ARBITRATOR, the JOINER |
| | completes the challenge and prepares to send the challenge back to the ARBITRATOR. |
| | The challenge can include the device's network certificate and/or a sideband-shared pin. |
| 2.j.c. | The JOINER prepares a counter-challenge for the ARBITRATOR to complete (e.g., a |
| | sequence of random bytes). |
| 2.j.d. | The following information is sent to the ARBITRATOR: a completed challenge; |
| | supplemental information for verifying the challenge (e.g., a certificate); a counter- |
| | challenge; and the ECDH public key. |
| 2.j.e. | The JOINER device waits for the completed counter-challenge from the |
| | ARBITRATOR. If none is received before a timeout, the authentication fails. |
| 2.j.f. | Once received, the counter-challenge is verified. This verification can include the |
| | ARBITRATOR's certificate and/or a sideband-shared PIN, etc. If the counter-challenge |
| | is not correct, the JOINER will not share security credentials with the ARBITRATOR, |
| | and the authentication fails. The challenge phase may not be retried. |
| 2.j.g. | If the counter-challenge is successful, an acknowledgement (ACK) is sent to the |
| | ARBITRATOR to notify the JOINER's willingness to proceed. |
| 2.j.h. | During authentication, all of the antecedents of a shared symmetric ephemeral key have |
| | been exchanged. The key may now be derived internally. |

Table 13 below describes the steps for the ARBITRATOR role process flow for secure subnet mutual authentication.

TABLE 13

| Step | Description |
|---|---|
| 2.a.a. | A challenge (e.g., a sequence of random bytes) is prepared for the JOINER by the |
| | ARBITRATOR. |
| 2.a.b. | The challenge is sent to the JOINER. |
| 2.a.c. | The ARBITRATOR device waits for the completed challenge from the JOINER. If |
| | none is received before a timeout, authentication fails, the JOINER is not provided with |
| | the necessary security credentials to join the subnet, and the ARBITRATOR device |
| | may resume normal behavior. The ARBITRATOR's host processor is informed of the |
| | failure, including the device's ID. |
| 2.a.d. | When the ARBITRATOR receives the challenge response from the JOINER, the |
| | response is verified by the ARBITRATOR. This verification can include the JOINER's |
| | certificate and/or a sideband-shared PIN, etc. If the challenge is not correct, the |
| | authentication fails and the JOINER is not provided with the necessary security |
| | credentials to join the subnet. The challenge phase may not be retried. |
| 2.a.e. | The counter-challenge from the JOINER contained in the message that also includes the |
| | JOINER's challenge response to the ARBITRATOR can now be completed by the |
| | ARBITRATOR. The counter-challenge can include the device's network certificate |
| | and/or a sideband-shared pin. |
| 2.a.f. | The following information is sent to the JOINER: a completed challenge; supplemental |
| | information for verifying challenge (e.g., a certificate); and the ECDH public key. |
| 2.a.g. | The ARBITRATOR waits for a counter-challenge ACK response from the JOINER to |
| | complete the mutual authentication process. If none is received, the authentication |
| | process fails. |
| 2.a.h. | During authentication, all of the antecedents of a shared symmetric ephemeral key have |
| | been exchanged. The key may now be derived internally. |

If any of the challenge verification steps fail, then the mutual authentication process fails and is not retried. However, such an outcome does not preclude a retry at a lower layer if the arriving message fails an integrity check. By way of example, such a retry can include retrying the transmission at the MAC layer versus the upper layers wherein the security protocol is implemented. Any failure during authentication also provides an opportunity for the ARBITRATOR device to update a deny list.

Additionally, in one or more embodiments, a secure channel establishment phase can accomplish the following: The ARBITRATOR shares one or more MAC-layer secrets with the JOINER, and the ARBITRATOR and JOINER adopt the one or more MAC-layer secrets for the remainder of the join process.

Table 14 below describes the steps for the JOINER role process flow for secure channel establishment.

TABLE 14

| Step | Description |
|---|---|
| 3.j.a. | The JOINER waits for the payload from the ARBITRATOR that contains the following |
| | information: a key derivation key (KDK); a MAC nonce; and an authentication tag. If |
| | the payload is never received, the process fails. |
| 3.j.b. | The JOINER decrypts the payload using the derived key from the authentication process |
| | detailed above. |
| 3.j.c. | The JOINER compares the computed authentication tag with the received authentication |
| | tag. If the two differ, the payload is deemed inauthentic. Note that packet integrity is |
| | ensured at the MAC layer, so an authentication tag error should not indicate a |
| | transmission issue. |
| 3.j.d. | If the authentication tag is deemed inauthentic, the JOINER sends a NAK response to |
| | the ARBITRATOR and the process fails. |
| 3.j.e. | If the tag is deemed authentic and/or valid, then the credentials are stored in non-volatile |
| | memory. |
| 3.j.f. | Once the credentials are stored, the JOINER sends an ACK to the ARBITRATOR. This |
| | signifies that the device has successfully received and stored the MAC credentials |
| 3.j.g. | For the next phase of the join process, the MAC credentials are used to encrypt the |
| | traffic. The credentials should be adopted at the MAC layer. |

Table 15 below describes the steps for the ARBITRATOR role process flow for secure channel establishment.

TABLE 15

| Step | Description |
|---|---|
| 3.a.a. | The ARBITRATOR prepares the MAC keys for transport. The message payload |
| | should include the following: a subnet KDK (encrypted); a subnet nonce (encrypted); |
| | and an authentication tag. |
| 3.a.b. | The payload is sent to the JOINER. |
| 3.a.c. | The ARBITRATOR device waits for an ACK from the JOINER. The process fails if |
| | no ACK is received before a timeout. Otherwise, the phase has been completed |
| | successfully. |

Also, in at least one embodiment, a subnet access phase is intended to enable the JOINER to receive the remaining subnet information required to access a configuration channel. With such information, the device may proceed to configure sockets on a device-by-device basis.

Table 16 below describes the steps for the JOINER and ARBITRATOR role process flow for subnet access.

TABLE 16

| Step | Description |
|---|---|
| 4.j.a. | The JOINER waits for the subnet definition message from the ARBITRATOR. The |
| | message payload includes all required subnet information, and if necessary, may occur |
| | over several transmissions. The payload may include: a partial subnet directory table; |
| | and one or more MAC/PHY parameters. If the payload is never received, the process |
| | fails. |
| 4.j.b. | The JOINER commits the information to MAV storage. |
| 4.j.c. | The JOINER then sends an ACK to the ARBITRATOR. At this point, the JOINER |
| | device may communicate within the subnet. |

Table 17 below describes the steps for the ARBITRATOR role process flow for subnet access

TABLE 17

| Step | Description |
|---|---|
| 4.a.a. | The ARBITRATOR derives the subnet definition required for the JOINER. In addition |
| | to subnet-scope parameters, this may also include calculation of derived traffic |
| | allowances based at least in part on the JOINER's service requirements. |
| 4.a.b. | The subnet definition is sent. If large, it may be fragmented over multiple packets. The |
| | transmissions should be encrypted with the subnet's credentials. |
| 4.a.c. | The ARBITRATOR waits for an ACK. If received, the JOINER is now a subnet |
| | member. If not, the process has failed. |

In at least one embodiment, once a device is admitted to a subnet and begins to communicate data traffic, the traffic is encrypted (e.g., using a 256-bit encryption algorithm such as AES-256) to secure the channel. More particularly, in such an embodiment, a symmetric-key-based authenticated encryption cipher mode can be used to provide data secrecy and authentication. In this class of cipher, a single key can be used for transforming plaintext into ciphertext, and for producing a message authentication code. Encryption standard that can be used in such an embodiment can include, for example, AES-CCM-256, AES-GCM-256, and AES-{GCM,CCM}-128.

In accordance with one or more embodiments, the data noted in Table 18 are required for one or more AES ciphers specified above.

TABLE 18

| | Size | |
|---|---|---|
| Input | (in bytes) | Description |
| Key | 32 | Shared between all parties |
| | | authorized for the communication. |
| Nonce | 16 | Input to generate the key stream. |
| Plaintext | Arbitrary | Provided by application. |

Also, in accordance with one or more embodiments, the data noted in Table 19 are produced by one or more AES ciphers specified above.

TABLE 19

| | | Ciphertext Size is |
|---|---|---|
| | | Identical to Plaintext |
| | | (Block Alignment/ |
| Ciphertext | Arbitrary | Padding Not Required) |
| Message | 4 | The native output length is 16 bytes, |
| | | but is truncated to |
| Authentication Code | | conserve payload. |

As also detailed herein, one or more embodiments include keystream input generation. In such an embodiment, AES requires that the nonce must be unique each time data is encrypted, and in a single encryption/decryption, the nonce must be incremented across blocks. These increments must not collide with any other counter value used. Also, the same nonce must be used by both the encryptor and decryptor for successful communication, and as such, all devices maintaining valid and/or acceptable communication must be able to synchronize and/or derive the same nonce value. To meet these expectations, in at least one embodiment, the nonce is managed in the following way with respect to creation, modification, and synchronization.

In connection with creation, a base nonce is created at the time that the subnet is created. In connection with modifications, at each encryption/decryption, the nonce can be modified using a nonce XOR modifier. Such a modifier can include, for example, a bit sequence that is unique for every transmission, and is long enough to ensure that values do not repeat over the lifetime of the subnet. In at least one example embodiment, the modifier includes at most 14 bytes, and two of the bytes are reserved for a counter.

Also, one or more embodiments include implementing synchronization techniques, wherein the modifier can be synchronized between subnet devices by using a timing value in the MAV network stack that has one or more designated properties (e.g., is of sufficient length, is strictly monotonic, varies with each packet transfer, and/or is synchronized across devices).

Additionally or alternatively, the modifier can be synchronized between subnet devices by explicitly synchronizing the nonce. In such an embodiment, the nonce may be shared, unencrypted, OTA at any point when the given device needs time synchronization, and nodes will have distributed logic to advance the modifier (e.g., for slotted transport, modifier++ at each slot transition, etc.). Within an encryption and/or decryption process, a counter can be used to modify the nonce after each block is generated. Such a counter can be, for example, two bytes in size, implying a maximum of 65536*16=1,048,576 bytes per transmission. Also, in such an embodiment, the counter and the modifier can be applied to non-overlapping bytes in the nonce, which ensures that changes in both the modifier and the counter do not accidentally result in repeated values.

As detailed herein, one or more embodiments include implementing the MAC on different PHYs (e.g., flexible PHY slot duration, number of slots per frame, etc.). Additionally, at least one embodiment can include synchronization of a network and maintaining synchronization through the exchange of synchronization packets during synchronization intervals and during any transmit operation, including a process which can include one or more SOF adjustments. Also, one or more embodiments include generating and/or utilizing at least one mesh implementation algorithm which can be used for establishing and maintaining a connection graph, distributing the graph and voting on who the repeater node(s) is/are going to be in the next frame.

Further, at least one embodiment includes enabling and/or leveraging PHY adaptability, wherein, for example, a MAC layer and an ad hoc voice (data) stack are adaptable to more than one PHY (e.g., using PCD format and content variations). Also, such an embodiment can include enabling and/or leveraging software portability of one or more upper layers (e.g., one or more applications) to one or more hardware-specific lower layers (e.g., an operating system with one or more hardware drivers). For example, Wi-Fi common MAC layers can sit on different 802.11 PHYs. At least one embodiment can also include enabling and/or leveraging the adaptability of a MAV stack to a PHY such as, e.g., Nordic DECT-2020 PHY, as well as synchronizing MACTIME to PHYTIME and vice versa.

FIG. 21 is a flow diagram of a process for implementing a wireless mobile ad hoc voice and data network in an illustrative embodiment. It is to be understood that this particular process is only an example, and additional or alternative processes can be carried out in other embodiments.

In this embodiment, the process includes steps 2100 through 2108. These steps are assumed to be performed by a first device (comprising, e.g., wireless communication system 600 utilizing elements 620, 630, 640 and 650).

Step 2100 includes transmitting at least one connection graph to one or more additional devices within an ad hoc mesh network, wherein the connection graph represents connectivity status in connection with at least a portion of the ad hoc mesh network. In at least one embodiment, Step 2102 includes contributing to electing a repeater device, from among the one or more additional devices, to retransmit in a subsequent transmission frame information transmitted by at least a portion of the one or more additional devices in a current transmission frame. In one or more embodiments, contributing to electing the repeater device further includes dedicating at least one communication slot in the subsequent transmission frame as at least one repeater slot for use by the elected repeater device. Additionally or alternatively, contributing to electing a repeater device can include contributing, in conjunction with dynamic mobility-based topology changes to the ad hoc mesh network, to electing a distinct repeater device for each of multiple transmission frames.

Also, in one or more embodiments, step 2102 can further include step 2104 and step 2106. Step 2104 includes using, upon a first condition that the first device transmitted during the current transmission frame, the connection graph to vote for one of the one or more additional devices. In at least one embodiment, using the connection graph to vote for one of the one or more additional devices includes using one or more repeater device vote-related data fields associated with the connection graph. Step 2106 includes processing, upon a second condition that the first device did not transmit during the current transmission frame, one or more votes from one or more transmitting devices to determine an identity of the elected repeater device. In one or more embodiments.

Step 2108 includes retransmitting, upon being elected as the repeater device, the information transmitted by the at least a portion of the one or more additional devices during the current transmission frame during the subsequent transmission frame. In at least one embodiment, retransmitting the information includes automatically processing one or more voice data transmissions in the ad hoc mesh network.

Additionally, in one or more embodiments, the techniques depicted in FIG. 21 can further include one or more of generating the connection graph and updating the connection graph based at least in part on processing one or more connection graphs received from the one or more additional devices. Also, such an embodiment can include completing one or more configuration actions required for establishing topology of the ad hoc mesh network prior to joining the ad hoc mesh network.

Accordingly, the particular processing operations and other functionality described in conjunction with the flow diagram of FIG. 21 are presented by way of illustrative example only, and should not be construed as limiting the scope of the disclosure in any way. For example, the ordering of the process steps may be varied in other embodiments, or certain steps may be performed concurrently with one another rather than serially.

As detailed herein, one or more embodiments also include generating and/or implementing a wireless communication system comprising an ad hoc mesh network comprising two or more devices, each device configured: to transmit a connection graph to each other device among the two or more devices, wherein the connection graph represents a connectivity status of the device transmitting the connection graph; and to contribute to electing a repeater device, from among the two or more devices, to retransmit in a subsequent transmission frame information transmitted by at least a portion of the two or more devices in a current transmission frame. In such an embodiment, contributing to electing the repeater device includes: using, upon a first condition that the device transmitted during the current transmission frame, the connection graph to vote for one of the two or more devices; processing, upon a second condition that the device did not transmit during the current transmission frame, one or more votes from one or more transmitting devices to determine an identity of the elected repeater device. Further, in such an embodiment, each device is configured to retransmit, upon being elected as the repeater device, the information transmitted by the at least a portion of the two or more devices during the current transmission frame during the subsequent transmission frame.

Additionally, at least one embodiment includes generating and/or implementing an apparatus comprising at least one processing device comprising a processor coupled to a memory, the at least one processing device being configured: to communicate over a wireless ad hoc mesh network; to transmit a connection graph to one or more additional processing devices within the wireless ad hoc mesh network, wherein the connection graph represents a connectivity status of the at least one processing device; and to contribute to electing a repeater device, from among the one or more additional processing devices, to retransmit in a subsequent transmission frame information transmitted by at least a portion of the one or more additional processing devices in a current transmission frame. In such an embodiment, contributing to electing the repeater device comprises: using, upon a first condition that the at least one processing device transmitted during the current transmission frame, the connection graph to vote for one of the one or more additional processing devices; and processing, upon a second condition that the at least one processing device did not transmit during the current transmission frame, one or more votes from one or more transmitting devices to determine an identity of the elected repeater device. Further, in such an embodiment, the at least one processing device is additionally configured to retransmit, upon being elected as the repeater device, the information transmitted by the at least a portion of the one or more additional processing devices during the current transmission frame during the subsequent transmission frame.

The above-described illustrative embodiments provide significant advantages relative to conventional approaches. For example, some embodiments are configured to implement mesh network topologies utilizing connection graphs and elected repeater nodes. These and other embodiments can effectively overcome problems associated with range limitations and significant cost and/or power requirements arising from fixed infrastructure network architectures.

It is to be appreciated that the foregoing advantages are illustrative of advantages provided in certain embodiments, and need not be present in other embodiments.

Additionally, the networks disclosed herein can be implemented, for example, using one or more processing platforms. Such a processing platform can include, by way of example, at least one processing device comprising a processor coupled to a memory.

The particular processing platforms described above are presented by way of example only, and a given network can include additional or alternative processing platforms, as well as numerous distinct processing platforms in any combination, with each such platform comprising one or more computers, servers, storage devices and/or other user devices.

It should again be emphasized that the embodiments described herein are presented for purposes of illustration only. Many variations may be made in the particular arrangements shown. Moreover, the assumptions made herein in the context of describing one or more illustrative embodiments should not be construed as limitations or requirements, and need not apply in one or more other embodiments. Numerous other alternative embodiments within the scope of the appended claims will be readily apparent to those skilled in the art.

What is claimed is:

1. A wireless communication system comprising:
an ad hoc mesh network comprising two or more devices, each device configured:
to transmit a connection graph to each other device among the two or more devices, wherein the connection graph represents a connectivity status of the device transmitting the connection graph;
to contribute to electing a repeater device, from among the two or more devices, to retransmit in a subsequent transmission frame information transmitted by at least a portion of the two or more devices in a current transmission frame, wherein contributing to electing the repeater device comprises:
using, upon a first condition that the device transmitted during the current transmission frame, the connection graph to vote for one of the two or more devices; and
processing, upon a second condition that the device did not transmit during the current transmission frame, one or more votes from one or more transmitting devices to determine an identity of the elected repeater device; and
to retransmit, upon being elected as the repeater device, the information transmitted by the at least a portion of the two or more devices during the current transmission frame during the subsequent transmission frame.

2. The wireless communication system of claim 1, wherein retransmitting the information comprises automatically processing one or more voice data transmissions in the ad hoc mesh network utilizing the elected repeater device.

3. The wireless communication system of claim 1, wherein contributing to electing the repeater device further comprises dedicating at least one communication slot in the subsequent transmission frame as at least one repeater slot for use by the elected repeater device.

4. The wireless communication system of claim 1, wherein using the connection graph to vote for one of the two or more devices comprises using one or more repeater device vote-related data fields associated with the connection graph.

5. The wireless communication system of claim 1, wherein contributing to electing a repeater device comprises contributing, in conjunction with dynamic mobility-based topology changes to the ad hoc mesh network, to electing a distinct repeater device for each of multiple transmission frames.

6. The wireless communication system of claim 1, wherein electing a repeater device comprises implementing a consensus-based process which precludes a need of any centralized system.

7. The wireless communication system of claim 1, wherein each device is further configured to implement one or more connection graph updates based at least in part on processing one or more connection graphs received from the other of the two or more devices.

8. The wireless communication system of claim 1, wherein each device is further configured to complete one or more configuration actions required for establishing topology of the ad hoc mesh network prior to forming the ad hoc mesh network with the one or more additional devices.

9. A computer-implemented method, carried out by a first device, comprising:
transmitting at least one connection graph to one or more additional devices within an ad hoc mesh network, wherein the connection graph represents connectivity status in connection with at least a portion of the ad hoc mesh network;
contributing to electing a repeater device, from among the one or more additional devices, to retransmit in a subsequent transmission frame information transmitted by at least a portion of the one or more additional devices in a current transmission frame, wherein contributing to electing the repeater device comprises:
using, upon a first condition that the first device transmitted during the current transmission frame, the connection graph to vote for one of the one or more additional devices; and
processing, upon a second condition that the first device did not transmit during the current transmission frame, one or more votes from one or more transmitting devices to determine an identity of the elected repeater device; and
retransmitting, upon being elected as the repeater device, the information transmitted by the at least a portion of the one or more additional devices during the current transmission frame during the subsequent transmission frame.

10. The computer-implemented method of claim 9, wherein retransmitting the information comprises automatically processing one or more voice data transmissions in the ad hoc mesh network.

11. The computer-implemented method of claim 9, wherein contributing to electing the repeater device further comprises dedicating at least one communication slot in the subsequent transmission frame as at least one repeater slot for use by the elected repeater device.

12. The computer-implemented method of claim 9, wherein using the connection graph to vote for one of the one or more additional devices comprises using one or more repeater device vote-related data fields associated with the connection graph.

13. The computer-implemented method of claim 9, wherein contributing to electing a repeater device comprises contributing, in conjunction with dynamic mobility-based topology changes to the ad hoc mesh network, to electing a distinct repeater device for each of multiple transmission frames.

14. The computer-implemented method of claim 9, further comprising one or more of generating the connection graph and updating the connection graph based at least in part on processing one or more connection graphs received from the one or more additional devices.

15. The computer-implemented method of claim 9, further comprising completing one or more configuration actions required for establishing topology of the ad hoc mesh network prior to joining the ad hoc mesh network.

16. An apparatus comprising:
at least one processing device comprising a processor coupled to a memory;
the at least one processing device being configured:
to communicate over a wireless ad hoc mesh network;
to transmit a connection graph to one or more additional processing devices within the wireless ad hoc mesh network, wherein the connection graph represents a connectivity status of the at least one processing device;
to contribute to electing a repeater device, from among the one or more additional processing devices, to retransmit in a subsequent transmission frame information transmitted by at least a portion of the one or more additional processing devices in a current transmission frame, wherein contributing to electing the repeater device comprises:
using, upon a first condition that the at least one processing device transmitted during the current transmission frame, the connection graph to vote for one of the one or more additional processing devices; and
processing, upon a second condition that the at least one processing device did not transmit during the current transmission frame, one or more votes from one or more transmitting devices to determine an identity of the elected repeater device; and
to retransmit, upon being elected as the repeater device, the information transmitted by the at least a portion of the one or more additional processing devices during the current transmission frame during the subsequent transmission frame.

17. The apparatus of claim 16, wherein retransmitting the information comprises automatically processing one or more voice data transmissions in the wireless ad hoc mesh network.

18. The apparatus of claim 16, wherein contributing to electing the repeater device further comprises dedicating at least one communication slot in the subsequent transmission frame as at least one repeater slot for use by the elected repeater device.

19. The apparatus of claim 16, wherein using the connection graph to vote for one of the one or more additional processing devices comprises using one or more repeater device vote-related data fields associated with the connection graph.

20. The apparatus of claim 16, wherein the at least one processing device is further configured to one or more of generating the connection graph and updating the connection graph based at least in part on processing one or more connection graphs received from the one or more additional processing devices.
